(19) United States
(12) Patent Application Publication
(10) Pub. No.: US 2013/0083277 A1
(43) Pub. Date: Apr. 4, 2013

(54) OPTICAL FILM, LIQUID CRYSTAL DISPLAY, TRANSFERRING MATERIAL, AND METHOD OF MANUFACTURING OPTICAL FILM

(71) Applicant: Fujifilm Corporation, Tokyo (JP)

(72) Inventors: Akira YAMAMOTO, Minami-ashigara-shi (JP); Hiroshi SATO, Minami-ashigara-shi (JP)

(73) Assignee: FUJIFILM CORPORATION, Tokyo (JP)

(21) Appl. No.: 13/628,767

(22) Filed: Sep. 27, 2012

(30) Foreign Application Priority Data
Sep. 30, 2011 (JP) 2011-218157

(51) Int. Cl. G02F 1/1337

(52) U.S. Cl. 349/123; 349/187

(57) ABSTRACT

An optical film, which exhibits a high, optically compensatory function and can be stably manufactured by continuous production, can be provided. The optical film comprises an optically anisotropic layer comprising discotic liquid crystal fixed into a hybrid alignment, an adhesion layer having no alignment controllability and a substrate in that order, wherein the hybrid alignment is conditioned such that an angle defined by a director of the discotic liquid crystal in a region close to an interface with air and the normal to the film is larger than an angle defined by a director of the discotic liquid crystal in the vicinity of an interface with the adhesion layer and the normal to the film, and the total thickness of the film is 0.1 μm to 70 μm.

The present application claims the benefit of priority from Japanese Patent Application No. 218157/2011, filed on Sep. 30, 2011, the contents of which is herein incorporated by reference in their entirety.

### BACKGROUND OF THE INVENTION

1. Field of the Invention

The present invention relates to an optical film useful as, for example, an optically compensatory film of a liquid crystal display, a transferring material used for manufacturing the optical film, and a method of manufacturing the optical film. In addition, the invention relates to a liquid crystal display including the optical film.

2. Description of the Related Art

Optically anisotropic layers including discotic liquid crystal with hybrid alignment have been proposed to be practically used for compensation of the viewing angle of TN-mode liquid crystal displays. Use of the optically anisotropic layers remarkably improves viewing angle characteristics of the TN-mode liquid crystal displays. In typical continuous production of optically compensatory films having such a configuration, while a long substrate film is being conveyed, an alignment layer is formed on a surface of the film, the alignment layer is then subjected to orientation control treatment such as rubbing treatment, a coating solution, which is beforehand prepared by dissolving a material for the optically anisotropic layer in an organic solvent, is applied on the alignment layer, and the applied solution is dried and cured, so that the optically anisotropic layer is formed. The substrate film requires certain strength since it is to be subjected to such many steps. The film, therefore, has a certain level of thickness (for example, 80 μm or more).

Flat-panel displays such as liquid crystal displays, however, have been increasingly demanded to be reduced in thickness, and optically compensatory films used for the flat-panel displays are also strongly demanded to be reduced in thickness. If a film having a small thickness (for example, about 40 μm) is used as a substrate film, however, an optically compensatory film having the configuration described above cannot be stably manufactured since the substrate film may be damaged during the continuous production.

Hybrid alignment used in the optically compensatory films can be classified into two alignment modes: a normal hybrid alignment mode in which an angle (hereinafter, referred to as tilt angle) between the director of each discotic liquid crystal molecule and the normal to the film increases from the interface with an alignment layer to the interface with air, and a reverse hybrid alignment mode in which the tilt angle decreases from the interface with the alignment layer to the interface with air. Although both alignment modes are effective for optical compensation for the TN-mode liquid crystal displays, the normal hybrid alignment mode is more preferred in terms of downward grayscale inversion (for example, see Japanese Patent No. 2587398). The discotic liquid crystal molecules in the vicinity of the interface with the alignment layer, however, must be in a horizontal alignment state (an alignment state with a disc plane parallel to a layer plane) in order to form the normal hybrid alignment state. Since small orientation control force in an azimuth direction is applied to the discotic liquid crystal molecules in the horizontal alignment state, slight deviation in orientation (hereinafter, referred to as slight orientation deviation) tends to occur in the normal hybrid alignment mode. The slight orientation deviation in the optically anisotropic layer causes a reduction in front contrast. In some cases, alignment must be controlled to be tilted at a low angle from completely horizontal alignment in order to optimize the optically compensatory function. Such a low tilt angle, however, is less likely to be achieved by orientation control force of the alignment layer at the interface with the alignment layer.

To solve these problems, an optically compensatory film including an optically anisotropic layer in a fixed reverse hybrid alignment has been proposed as is disclosed in Japanese Unexamined Patent Application Publication No. 2011-133549. Such an optically compensatory film, however, cannot achieve the above-described reduction in thickness, and cannot achieve use of normal hybrid alignment ideal for optical compensation.

### SUMMARY OF THE INVENTION

An object of the present invention is to solve the above-described problems.

Specifically, an object of the invention is to provide a thin optical film that exhibits a high, optically compensatory function, and can be stably manufactured by continuous production, and a liquid crystal display including the optical film.

Another object of the invention is to provide a transferring material useful for manufacturing the optical film, and a method of manufacturing the transferring material.

[1] An optical film comprising, an optically anisotropic layer comprising discotic liquid crystal fixed into a hybrid alignment, an adhesion layer having no alignment controllability and a substrate in that order,

wherein the hybrid alignment is conditioned such that an angle defined by a director of the discotic liquid crystal in a region close to an interface with air and the normal to the film is larger than an angle defined by a director of the discotic liquid crystal in the vicinity of an interface with the adhesion layer and the normal to the film, and

the total thickness of the film is 0.1 μm to 70 μm.

[2] The optical film of [1], wherein the hybrid alignment is conditioned such that the angle defined by the director of the discotic liquid crystal in the vicinity of the interface with the adhesion layer and the normal to the film is 0° to 40°, and the angle defined by the director of the discotic liquid crystal in the region close to the interface with air and the normal to the film is 50° to 90°.

[3] The optical film of [1] or [2], wherein the optically anisotropic layer further comprises at least one of compounds represented by formula (1):

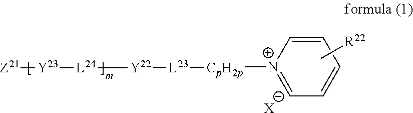

wherein L²³ and L²⁴ each represent a divalent linking group; R²² represents a hydrogen atom, an unsubstituted amino group, or a substituted amino group containing 1 to 20 carbon atoms; X represents an anion, Y²² and Y²³ each represent a divalent linking group having an optionally substituted five- or six-membered ring as a partial structure; Z²¹ represents a monovalent group selected from the group consisting of alkyl groups containing 13 to 20 carbon atoms, alkynyl groups containing 13 to 20 carbon atoms, and alkoxy groups containing 13 to 20 carbon atoms; p is an integer of 1 to 10; and m is 1 or 2.

[4] The optical film of [3], wherein the proportion of at least one of the compounds represented by formula (1) contained in the optically anisotropic layer is preferably 1 to 5 parts by mass to 100 parts by mass of the discotic liquid crystal.

[5] The optical film of any one of [1] to [4], wherein the substrate is a polymer film.

[6] The optical film of [5], wherein the polymer film has a retardation along the thickness direction Rth of 0 nm to 80 nm.

[7] The optical film of any one of [1] to [4], wherein the substrate is a polarizer.

[8] A liquid crystal display comprising:

the optical film of any one of [1] to [12].

[9] A transfer material comprising, an optically anisotropic layer to be transferred comprising discotic liquid crystal molecules comprising discotic liquid crystal fixed into a hybrid alignment, a rubbed alignment layer; and a provisional substrate in that order;

Wherein the hybrid alignment is conditioned such that an angle defined by a director of the discotic liquid crystal in a region close to an interface with air and the normal to a film is smaller than an angle defined by a director of the discotic liquid crystal in the vicinity of an interface with the alignment layer and the normal to the film, and

the optically anisotropic layer to be transferred is separable from the alignment layer at an interface between the optically anisotropic layer and the alignment layer.

[10] The transfer material of [9], wherein the hybrid alignment is conditioned such that the angle defined by the director of the discotic liquid crystal in the vicinity of the interface with the alignment layer and the normal to the film is 50° to 90°, and the angle defined by the director of the discotic liquid crystal in the region close to the interface with air and the normal to the film is 0° to 40°.

[11] The transfer material of [9] or [10], wherein the optically anisotropic layer to be transferred further comprises at least one of the compounds represented by formula (1) described in [3].

[12] The transfer material of [11], wherein the proportion of at least one of the compounds represented by the formula (1) contained in the optically anisotropic layer to be transferred is preferably 1 to 5 parts by mass to 100 parts by mass of the discotic liquid crystal.

[13] The transfer material of any one of [9] to [12], wherein the alignment layer comprises unmodified or modified polyvinyl alcohol as a main component.

[14] The transfer material of [13], wherein a water contact angle on a surface close to the alignment layer of the provisional substrate is 10° to 50°.

[15] A method of manufacturing the optical film of any one of [1] to [7], the method comprising, in the sequence set forth of:

preparing the transferring material of any one of [9] to [14], and a laminate comprising a substrate and an adhesion layer or adhesion precursor layer having no alignment controllability on a surface of the substrate;

bringing a surface on a side close to the optically anisotropic layer to be transferred of the transferring material into contact with a surface of the adhesion layer or a surface of the adhesion precursor layer of the laminate; and

separating the provisional substrate and the alignment layer from the transferring material, thereby transferring the optically anisotropic layer onto the surface of the adhesion layer.

According to the invention, an optical film, which exhibits a high, optically compensatory function and can be stably manufactured by continuous production, can be provided. In addition, a liquid crystal display including the optical film can be provided.

Moreover, according to the invention, a transferring material useful for manufacturing the optical film and a method of manufacturing the transferring material can be provided.

### BRIEF DESCRIPTION OF THE DRAWINGS

FIG. 1 is a schematic sectional view of an exemplary optical film of the present invention.

FIG. 2 is a schematic perspective view of an exemplary optically anisotropic layer according to the invention.

FIG. 3 is a schematic sectional view of an exemplary transferring material of the invention.

FIG. 4 is a schematic perspective view of an exemplary optically anisotropic layer to be transferred according to the invention.

FIG. 5 is a schematic illustration of a flow of a method of manufacturing an optical film according to an embodiment of the invention.

FIG. 6 is a schematic illustration of another flow of the method of manufacturing the optical film according to the embodiment of the invention.

### BEST MODE FOR CARRYING OUT THE INVENTION

The present invention is now described in detail.

In this specification, numerical value ranges and numerical values should be interpreted as those including allowable errors in the technical field that the present invention belongs to.

In addition, the meanings of the terms “optical film” and “transferring material” in this specification each include any of practical forms such as a rectangular shape, elongated forms provided by continuous production, and rolled forms provided by winding elongated films. The same holds true for the terms “polymer film” and “polarizing film”.

### 1. Optical Film

The present invention relates to an optical film including an optically anisotropic layer containing discotic liquid crystal fixed into a hybrid alignment, an adhesion layer having no alignment controllability, and a substrate in this order,

wherein the hybrid alignment is conditioned such that an angle defined by the director of the discotic liquid crystal in a region close to an interface with air and the normal to the film is larger than an angle defined by the director of the discotic liquid crystal in the vicinity of an interface with the adhesion layer and the normal to the film, and the total thickness of the film is 0.1 μm to 70 μm. The optical film of the invention, including the optically anisotropic layer containing the discotic liquid crystal fixed into the hybrid alignment state, exhibits high, optically compensatory function for TN-mode liquid crystal displays. Furthermore, the optical film has a small total thickness in the range as described above, and is suitable for optical compensation of flat panel displays for tablet PCs, mobile phones, and other devices, among various types of TN-mode liquid crystal displays.

In the optical film of the invention, the adhesion layer, which is disposed between the substrate and the optically anisotropic layer, has no alignment controllability. Thus, an optically anisotropic layer is separately provided on an alignment layer having alignment controllability, and then transferred onto the adhesion layer. Commonly, in normal hybrid alignment of discotic liquid crystal, the liquid crystal is substantially horizontally aligned in the vicinity of the interface with the alignment layer. As a result, control force is small in the azimuth direction, and slight orientation deviation tends to significantly occur in a microscopic scale with respect to the alignment direction caused by rubbing of the alignment layer, for example. In the present invention, an optically anisotropic layer to be transferred, which is in a fixed reverse hybrid alignment state, is formed, and the optically anisotropic layer is then transferred onto an adhesion layer, thereby an interface with an alignment layer of the optically anisotropic layer before the transfer is changed to an interface with air, and an interface with air thereof is changed to an interface with the adhesion layer, so that an optically anisotropic layer, which is in a fixed normal hybrid alignment state, is formed on the substrate. This eliminates the problem of the slight orientation deviation that occurs during formation of the normal hybrid alignment. For example, the optically anisotropic layer according to the invention enables 3σ, which indicates a level of the slight orientation deviation, of 2.0 degrees or less. Since the optically anisotropic layer has no slight orientation deviation, if the optical film of the invention is used for a liquid crystal display, optical compensation is achieved without a reduction in front contrast (front CR).

In this specification, the “slight orientation deviation” in the optically anisotropic layer is calculated in the following way.

A retardation film having an optically anisotropic layer composed of a liquid crystal composition is photographed at a magnification of 400 with a digital camera. The photographs are taken using a polarizing microscope having polarizing plates arranged in a cross nicol relationship at a stage angle within a range of ±10 degrees about a stage angle of a darkest image while the stage angle is rotated every 0.5 degrees. The image taken by the digital camera is then subjected to rotation/translation to accurately adjust the position of the image in pixel unit. The angle of the darkest image is then recorded at every pixel, and a histogram is created by plotting angles in the horizontal axis and plotting the number of pixels each having the darkest image at each angle. The standard deviation σ is then determined from the histogram, and 3σ from the σ. A generally known polarizing microscope can be used, for example, Eclipse E600POL available from Nikon. The rotation/translation of the image can be performed using a commercially available program.

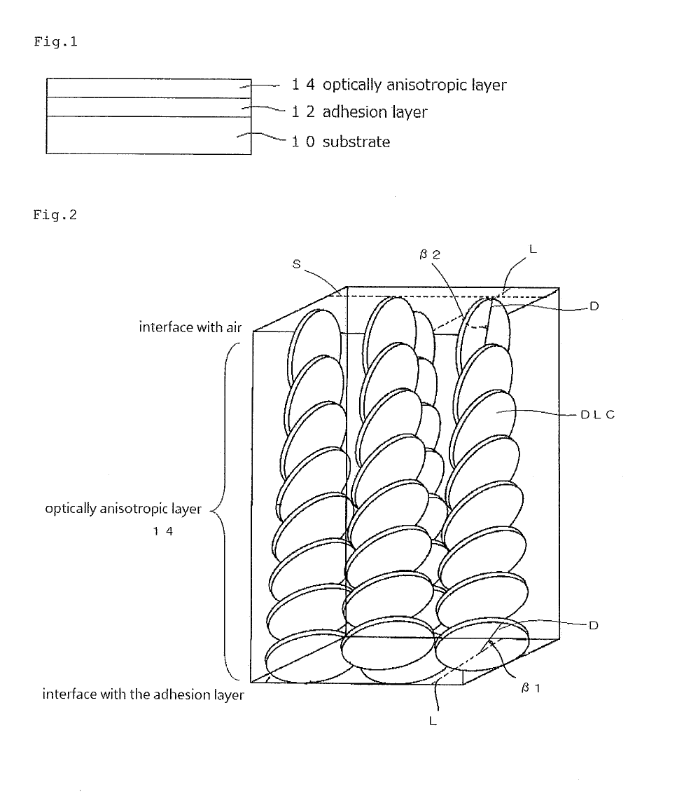

FIG. 1 is a schematic sectional view of an exemplary optical film of the present invention. The optical film illustrated in FIG. 1 includes a substrate 10, and an adhesion layer 12, and an optically anisotropic layer 14 in this order on the substrate 10. The optical film is a thin film. Specifically, the optical film has a total thickness of 0.1 μm to 70 μm, preferably 0.1 μm to 60 and more preferably 0.1 μm to 40 μm. If the optical film is directly transferred onto a polarizing film, the total thickness is preferably 0.1 μm to 5 μm, and more preferably 0.1 μm to 3 μm. If the optical film is transferred onto a polymer film, the total thickness is 20 μm to 70 μm preferably 20 μm to 60 μm and more preferably 20 μm to 40 μm.

The adhesion layer 12 has no alignment controllability. Thus, an optically anisotropic layer is separately provided on an alignment layer having alignment controllability, and then is transferred onto the adhesion layer 12, resulting in formation of the optically anisotropic layer 14 disposed on the adhesion layer 12. The adhesion layer 12 contains an adhesive agent that improves adhesiveness to the optically anisotropic layer 14. The adhesion layer 12 is preferably formed by curing an acrylic, vinyl acetate, polyamide, vinyl chloride, chloroprene rubber, epoxy, or isocyanate adhesive agent, and is more preferably formed by curing an ultraviolet curable adhesive agent (specifically, an adhesive agent composed of epoxy acrylate, urethane acrylate, and/or cyanoacrylate).

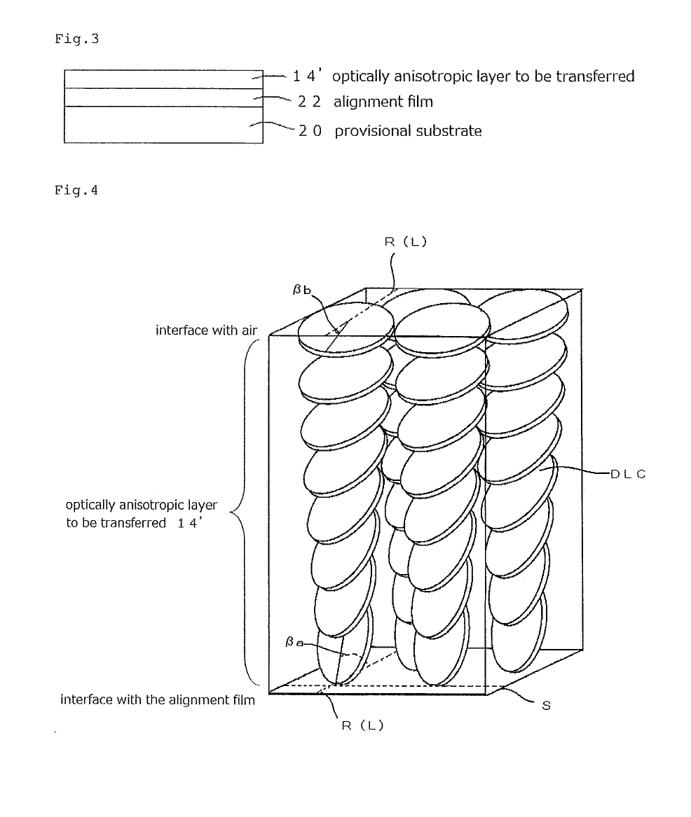

The optically anisotropic layer 14 contains discotic liquid crystal fixed into the normal hybrid alignment state. FIG. 2 is an enlarged schematic view of an exemplary optically anisotropic layer 14. The optically anisotropic layer 14 illustrated in FIG. 2 has an interface with the adhesion layer and an interface with air, and has a fixed mode of hybrid alignment where the angle β2 defined by the director D of the discotic liquid crystal DLC in a region close to the interface with air and the normal to the film is larger than the angle β1 defined by the director D of the discotic liquid crystal DLC in the vicinity of the interface with the adhesion layer and the normal to the film (β1<β2). Although each range of β1 and β2 is not limited within the range satisfying β1<β2, β1 of 0° to 40° and β2 of 50° to 90° are preferred in order to exhibit a high, optical compensation function. More preferably, β1 is 0° to 20° and β2 is 60° to 90°, and most preferably, β1 is 5° to 20° and β2 is 60° to 80°.

As described above, the slight orientation deviation of the director D of the discotic liquid crystal DLC in the optically anisotropic layer 14 is small in the vicinity of the interface with the alignment layer. Specifically, the 3σ indicating a level of the slight orientation deviation is 2.0 degrees or less. In the typical normal hybrid alignment, the alignment of the DLC in the vicinity of the interface with the alignment layer is mainly controlled by the alignment controllability of the alignment layer. The tilt angle of the DLC in the vicinity of the interface with the alignment layer, however, has not been appropriately adjusted within a range of 0° to 40°, particularly within a range of 15° to 40°, only by the alignment controllability of the alignment layer. In contrast, alignment of the discotic liquid crystal in the vicinity of the interface with air can be adjusted with an additive. For example, the tilt angle of the DLC in the vicinity of the interface with air is relatively readily adjusted within the range of 0° to 40° through addition of an air-interface horizontal-alignment accelerator. As described above, the interface with the adhesion layer of the optically anisotropic layer 14 corresponds to the interface with air of the optically anisotropic layer before the transfer. This enables a normal hybrid alignment state over a wide range of tilt angle β1 of DLC of 0° to 40° in the vicinity of the interface with the adhesion layer. The tilt angle β1 can be appropriately adjusted over the wide range as described above. This readily provides a tilt angle required for optical compensation for each mode of a liquid crystal display, such as TN, VA, IPS, OCB, and ECB.

In general, the thickness of the optically anisotropic layer 14 is preferably, but not limited to, 0.1 μm to 2.0 μm, and more preferably 0.5 μm to 2.0 μm.

There is no restriction on the substrate 10. The thickness of the substrate 10 is preferably 60 μm or less, and more preferably 40 μm or less since the total thickness of the optical film is limited within the above-described range. Since the optically anisotropic layer 14 is prepared by transferring as described above, an extremely low load than ever is exerted on the substrate 10 throughout the manufacturing process of the optical film. This prevents a significant reduction in productivity due to, for example, damage of the substrate 10 even if the substrate 10 is weak due to its small thickness within the range as described above. In general, the lower limit of the thickness of the substrate 10 is preferably 20 μm or more, and more preferably 30 μm or more.

An example of the substrate 10 is a transparent film mainly composed of a polymer (which includes both polymer and resin). The transparent film may be a retardation film that contributes to the optically compensatory function together with the optically anisotropic layer 14. In general, downward grayscale inversion readily occurs in the TN-mode liquid crystal display. If the substrate 10 has a retardation along the thickness direction Rth of 0 nm to 80 nm (preferably, 0 nm to 60 nm, and more preferably, 10 nm to 60 nm), grayscale inversion can be reduced in both horizontal and vertical directions. Such an optical film having the Rth in the above-described range is suitably used as the substrate 10 for a tablet display panel, a mobile phone, and other displays that may be rotated 360 degrees for observation.

Another example of the substrate 10 is a polarizing film. If the optically anisotropic layer 14 is directly laminated to the surface of the polarizing film with the adhesion layer 12 therebetween, the total thickness of a laminate of the optical film and a polarization plate can be further reduced, contributing to a reduction in thickness of the liquid crystal display. Any of generally used polarizing film can be used without limitation. An example of the polarizing film is a stretched polyvinyl alcohol film on which iodine is adsorbed.

In an embodiment where the optical film of the invention is continuously manufactured into an elongated shape, i.e., the substrate 10 has an elongated shape, as illustrated in FIG. 2, the slow axis S of the optically anisotropic layer 14 is preferably orthogonal to the longitudinal direction L of the substrate 10. For example, in an embodiment where the substrate 10 is a polarizing film, the polarizing film has an absorption axis in the longitudinal direction L; hence, the slow axis S of the optically anisotropic layer 14 is preferably orthogonal to the absorption axis. If the optical film of the invention is manufactured with a transferring material described later, and if transferring is performed in a roll-to-roll manner, the longitudinal direction of the substrate corresponds to the longitudinal direction of a provisional substrate of the transferring material. Furthermore, in the case where a surface of an alignment layer is continuously rubbed, the rubbing direction in general corresponds to the longitudinal direction. Thus, the discotic liquid crystal is preferably aligned such that the slow axis thereof is orthogonal to a rubbing direction during manufacture of the transferring material in order to manufacture the optical film in which the slow axis S of the optically anisotropic layer 14 is orthogonal to the longitudinal direction L of the substrate 10.

### 2. Transferring Material

The present invention further relates to a transferring material including, in that order, an optically anisotropic layer to be transferred composed of discotic liquid crystal fixed into hybrid alignment, a rubbed alignment layer, and a provisional substrate,

wherein the hybrid alignment is conditioned such that the angle defined by the director of discotic liquid crystal in a region close to an interface with air and the normal to the film is larger than the angle defined by the director of discotic liquid crystal in the vicinity of an interface with the alignment layer and the normal to the film, and the optically anisotropic layer to be transferred and the alignment layer can be separated from each other at the interface between them. The transferring material of the invention is useful for manufacture of the optical film of the invention. Specifically, use of the transferring material of the invention enables a thin optical film to be stably manufactured, the optical film including the optically anisotropic layer composed of the discotic liquid crystal fixed into the normal hybrid alignment state, and exhibiting a high, optically compensatory function for the TN-mode liquid crystal display.

FIG. 3 is a schematic sectional view of an exemplary transferring material of the present invention. The transferring material illustrated in FIG. 3 includes a provisional substrate 20, and an alignment layer 22 and an optically anisotropic layer to be transferred 14′ in this order on the provisional substrate 20. The provisional substrate 20 and the alignment layer 22 are each not necessary to be thin since they are separated from the optically anisotropic layer to be transferred 14′ and are not actually used. The transferring material is in general a laminate having a total thickness of about 70 μm to 200 μm.

The alignment layer 22 has alignment controllability, and controls the alignment of the discotic liquid crystal during formation of the optically anisotropic layer to be transferred 14′. The type of the alignment layer 22 is not limited. An exemplary alignment layer 22 is a rubbing alignment layer including a polymer film having a rubbed surface. Examples of the main component of the polymer film include modified or unmodified polyvinyl alcohol (PVA). Other alignment layers such as a photo alignment layer may also be used.

The optically anisotropic layer to be transferred 14′ contains the discotic liquid crystal fixed into a reverse hybrid alignment state. FIG. 4 is an enlarged schematic view of an exemplary optically anisotropic layer to be transferred 14′. The optically anisotropic layer to be transferred 14′ illustrated in FIG. 4 has an interface with the alignment layer and an interface with air, and has a fixed mode of hybrid alignment where the angle βb defined by the director D of the discotic liquid crystal DLC in a region close to the interface with air and the normal to the film is smaller than the angle βa defined by the director D of the discotic liquid crystal DLC in the vicinity of the interface with the alignment layer and the normal to the film (βb<βa). After the optically anisotropic layer 14′ is transferred, βa and βb correspond to β2 and β1, respectively, in FIG. 3. Consequently, βa of 50° to 90° and βb of 0° to 40° are preferred in order to manufacture an optical film exhibiting a high, optical compensation function. More preferably, βa is 60° to 90° and βb is 0° to 20°, and most preferably, βa is 60° to 80° and βb is 5° to 20°.

The transferring material is configured such that the alignment layer 22 can be separated from the optically anisotropic layer to be transferred 14′. If the main component of the alignment layer 22 is a hydrophilic material such as PVA, the alignment layer 22 has low affinity for the lipophilic liquid crystal, leading to high peelability. Furthermore, one of the additives contained in the optically anisotropic layer to be transferred 14′ preferably facilitates the separation. For example, the optically anisotropic layer to be transferred 14′ contains an additive that has a partial structure affinitive with a material (for example, PVA) of the alignment layer and a partial structure non-affinitive with the material, and that contains no reactive group being chemically bound with a component of the alignment layer 22, facilitating the separation. The additive preferably has another function. For example, the additive is preferably an alignment control agent that controls the alignment of the discotic liquid crystal at the interface with the alignment layer. The proportion of the additive is adjusted to facilitate the separation and to control the alignment of the discotic liquid crystal at the interface with the alignment layer into a desired state. Detail of the additive and a preferred amount thereof are described later.

There is no restriction on the provisional substrate 20. Since the provisional substrate 20 is separated and removed from the optically anisotropic layer to be transferred 14′ during the transfer, there is no restriction on the provisional substrate 2 in light of materials, optical characteristics, and other factors. A variety of generally used polymer films can be used. Loads are exerted on the provisional substrate 20 throughout the manufacturing process of the transferring material: a load exerted during formation of the alignment layer 22 and the optically anisotropic layer to be transferred 14′, and a load exerted due to conveyance in continuous production. In consideration of such loads, a polymer film having a certain level of strength is preferably used. For example, a film having a thickness of 80 μm or more is preferably used.

During the transfer, the alignment layer 22 and the optically anisotropic layer to be transferred 14′ are preferably separated from each other at the interface between them. If the alignment layer 22 is partially left on the optically anisotropic layer to be transferred 14′, the optically anisotropic layer 14 formed after the transfer may become less uniform. A higher affinity of the alignment layer 22 with the provisional substrate 20 is preferred to enable the alignment layer 22 and the optically anisotropic layer to be transferred 14′ to be separated at the interface therebetween. For example, the surface of the provisional substrate 20 is preferably hydrophilic in an embodiment where the main component of the alignment layer 22 is a hydrophilic material such as unmodified or modified PVA. The water contact angle is an index of surface hydrophilicity. In the embodiment, the water contact angle on the surface of the provisional substrate 20 is preferably 10° to 50°, and more preferably 10° to 40°.

In an embodiment where the transferring material of the invention is continuously manufactured into an elongated shape, and the surface of the alignment layer provided thereon is continuously rubbed, the rubbing direction in general corresponds to the longitudinal direction of the provisional substrate. Hence, as illustrated in FIG. 4, the longitudinal direction L of the provisional substrate 20 in general corresponds to the rubbing direction R. Furthermore, when the discotic liquid crystal is aligned at a high tilt angle on a rubbed surface, the discotic liquid crystal is in general aligned such that each disk plane is fitted in each of small recesses formed on the surface by the rubbing treatment. The slow axis exhibited in such an alignment state is parallel to the rubbing direction, i.e., the longitudinal direction. As described above, however, the slow axis S of the optically anisotropic layer 14, which is formed after the transfer of the optically anisotropic layer to be transferred 14′, is preferably orthogonal to the longitudinal direction from the viewpoint of productivity, for example. Hence, an alignment control agent, which accelerates the slow axis S of the discotic liquid crystal to be aligned orthogonally to the rubbing direction R (the longitudinal direction L of the provisional substrate 20), is preferably added during formation of the optically anisotropic layer to be transferred 14′.

Alternatively, an alignment control agent, which accelerates the discotic liquid crystal in the vicinity of the interface with air to be substantially horizontally aligned at a low tilt angle (to be aligned with each disk plane parallel to a layer surface), may be added into the optically anisotropic layer to be transferred 14′. The tilt angle of the discotic liquid crystal in the vicinity of the interface with air can be accurately controlled by adjusting the type and/or the amount of the additive. This leads to a stable alignment state compared with an alignment state in the case of controlling the tilt angle of the discotic liquid crystal in the vicinity of the interface with the alignment layer. Thus, the optically anisotropic layer 14′ is transferred so that the interface with air and the interface with the alignment layer are reversed. This results in the optically anisotropic layer 14 in the normal hybrid alignment, in which no slight orientation deviation occurs, and the tilt angle at each interface is accurately controlled to be within a desired range.

### 3. Method of Manufacturing Optical Film

The present invention also relates to a method of manufacturing the optical film of the invention with the transferring material of the invention. Specifically, the present invention also relates to a method of manufacturing the optical film of the invention, the method including, in the sequence set forth of:

preparing the transferring material of the invention, and a laminate including a substrate and an adhesion layer or adhesion precursor layer having no alignment controllability on a surface of the substrate (step (a));

bringing a surface on a side close to the optically anisotropic layer to be transferred of the transferring material into contact with a surface of the adhesion layer of the laminate (step (b)); and

separating a provisional substrate and an alignment layer from the transferring material, and transferring the optically anisotropic layer to be transferred onto the surface of the adhesion layer (step (c)).

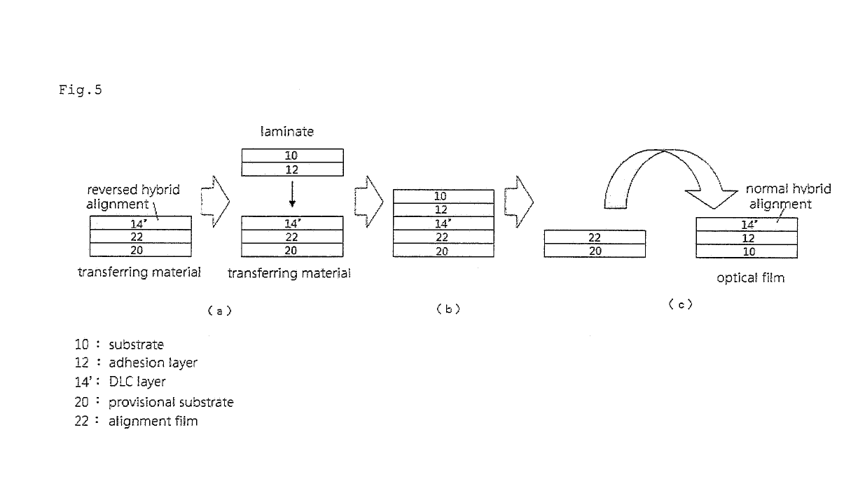

FIG. 5 is a schematic view of an exemplary method of manufacturing the optical film of the invention. Each step is now described with reference to FIG. 5.

### Step (a)

The transferring material of the invention, and the laminate, which includes the substrate and the adhesion layer or adhesion precursor layer having no alignment controllability on the surface of the substrate, are prepared. The transferring material of the invention can be manufactured using typically known methods. An example of the method is as follows.

A polymer film mainly containing, for example, PVA is formed on the provisional substrate 20, and the surface of the polymer film is rubbed, thereby the alignment film 22 is formed. Discotic liquid crystal and one or more alignment control agent if required are dissolved in an organic solvent to prepare a coating solution. The coating solution is then applied on the rubbed surface to form a coating layer. The coating layer is dried by heating if required so that the solvent is removed, and the discotic liquid crystal is aligned to form a reverse hybrid alignment state. A reactive component such as a polymerizable component (for example, discotic liquid crystal having a reactive group such as a polymerizable group) is reacted to fix the reverse hybrid alignment state, thereby the optically anisotropic layer to be transferred 14′ (the DLC layer 14′ in FIG. 4) is formed. In this way, the transferring material of the invention can be manufactured.

A laminate including the substrate 10 and the adhesion layer 12 thereon is separately prepared. The adhesion layer 12 may not be adhesive before being laminated to the transferring material. In other words, the adhesion layer 12 may be an adhesion precursor layer. For example, a laminate including an adhesion precursor layer, which is modified into the adhesion layer 12 through light irradiation or heat application after being laminated to the transferring material, may be prepared.

### Step (b)

The surface on a side close to the optically anisotropic layer to be transferred 14′ of the prepared transferring material is then brought into contact with the surface of the adhesion layer (or the adhesion precursor layer) 12 of the prepared laminate. The surfaces are preferably pressed while being in contact with each other. For example, a new laminate, which is formed by laminating the transferring material and the laminate under the above-described condition, is allowed to pass through a space between a pair of rolls so as to be pressed. In an embodiment where the adhesion precursor layer, which exhibits adhesiveness through light irradiation (for example, UV irradiation) or heating, is provided instead of the adhesion layer, the light irradiation and/or heating is preferably carried out during, before, or after the pressing.

### Step (c)

The provisional substrate 20 and the alignment layer 22 are then separated from the transferring material, so that the optically anisotropic layer to be transferred 14′ is transferred onto the surface of the adhesion layer 12, thereby the optically anisotropic layer 14 (the DLC layer 14 in FIG. 2) is formed. The interfaces are reversed by the transfer: the interface with air of the optically anisotropic layer to be transferred 14′ becomes the interface with the adhesion layer of the optically anisotropic layer 14 whereas the interface with the alignment film of the optically anisotropic layer to be transferred 14′ becomes the interface with air of the optically anisotropic layer 14. As a result, the discotic liquid crystal in the optically anisotropic layer 14 is fixed into the normal hybrid alignment state.

For example, the provisional substrate 20 and the alignment layer 22 may be separated in such a manner that a material such as a roll having a strongly tacky layer on its surface is brought into contact with the back (a side having no alignment layer 22 thereon) of the provisional substrate 20, thereby the provisional substrate 20 and the alignment layer 22 are exclusively separated by the tacking force of the material.

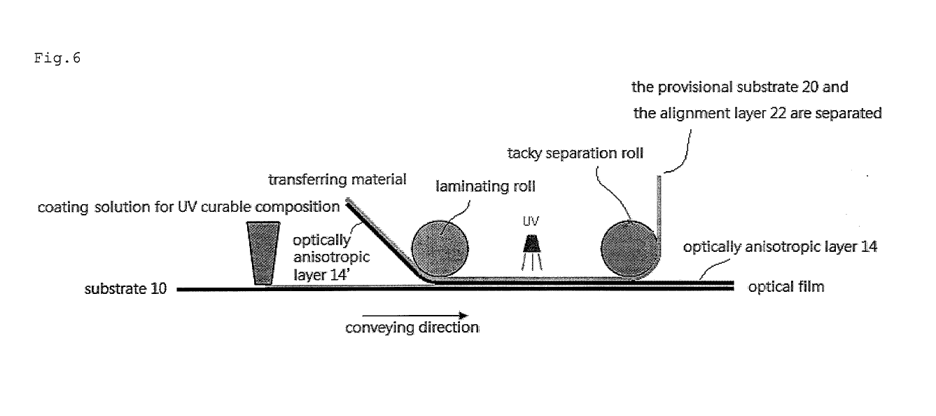

In the method of manufacturing the optical film of the invention, the optical film may be continuously processed into an elongated shape. FIG. 6 schematically illustrates an exemplary process flow of an embodiment of such continuous production. In the embodiment illustrated in FIG. 6, the method of the invention is carried out as follows.

An elongated transferring material, which includes the optically anisotropic layer to be transferred 14′ having the discotic liquid crystal fixed into the reverse hybrid alignment, is beforehand prepared on the provisional substrate including a long polymer film by the above-described method, for example. While the substrate 10 including a long polymer film is being conveyed in an arrow direction, a coating solution including a UV curable composition is applied on the surface of the substrate 10, thereby an adhesion precursor layer is continuously formed (step (a)).

The transferring material and the substrate 10 are allowed to pass through a space between a pair of laminating rolls, or a space under a laminating roll, thereby the surface of the optically anisotropic layer to be transferred 14′ is brought into contact with the surface of the adhesion precursor layer so that the transferring material and the substrate 10 are laminated. Here, the adhesion precursor layer is irradiated with UV light to cure the UV curable composition, resulting in firm adhesion between the optically anisotropic layer to be transferred 14′ and the adhesion layer (step (b)).

The back of the provisional substrate 20 is then brought into contact with the surface of the tacky separation roll having a tacky surface layer, and thus the provisional substrate 20 and the alignment layer 22 are separated due to the tacking force of the roll, so that the optically anisotropic layer to be transferred 14′ is transferred onto the substrate 10. The interfaces are reversed by the transfer: the interface with air of the optically anisotropic layer to be transferred 14′ becomes the interface with the adhesion layer of the optically anisotropic layer 14 whereas the interface with the alignment film of the optically anisotropic layer to be transferred 14′ becomes the interface with air of the optically anisotropic layer 14. As a result, the optically anisotropic layer 14 including the discotic liquid crystal fixed into the normal hybrid alignment state is formed on the substrate 10.

The materials usable for the present invention are now described. Hereinafter, the term “optically anisotropic layer” includes the optically anisotropic layer to be transferred of the transferring material, and the term “interface with air” refers to the interface between air and the optically anisotropic layer before transfer.

### (1) Optically Anisotropic Layer

### (1)-1 Discotic Liquid Crystal

There is no restriction on the discotic liquid crystal usable in the invention. Any compound classified as discotic liquid crystals can be used. Among them, nematic discotic liquid crystals are preferred. In particular, a discotic liquid crystal compound represented by the following formula (I) is preferred.

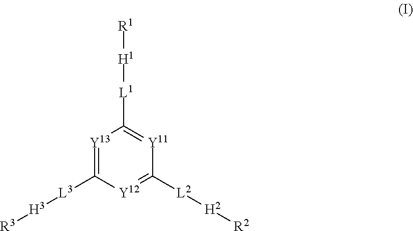

In the formula, Y¹¹, Y¹² and Y¹³ each independently represent a methine group or a nitrogen atom.

When each of Y¹¹, Y¹² and Y¹³ each is a methine group, the hydrogen atom of the methine group may be substituted with a substituent. Examples of the substituent of the methine group include an alkyl group, an alkoxy group, an aryloxy group, an acyl group, an alkoxycarbonyl group, an acyloxy group, an acylamino group, an alkoxycarbonylamino group, an alkylthio group, an arylthio group, a halogen atom, and a cyano group. Among those, preferred are an alkyl group, an alkoxy group, an alkoxycarbonyl group, an acyloxy group, a halogen atom and a cyano group; more preferred are an alkyl group having from 1 to 12 carbon atoms, an alkoxy group having from 1 to 12 carbon atoms, an alkoxycarbonyl group having from 2 to 12 carbon atoms, an acyloxy group having from 2 to 12 carbon atoms, a halogen atom and a cyano group.

Preferably, Y¹¹, Y¹² and Y¹³ are all methine groups, more preferably non-substituted methine groups, in terms of easiness in preparation of the compound.

In the formula, L¹, L² and L³ each independently represent a single bond or a bivalent linking group.

The bivalent linking group is preferably selected from —O—, —S—, —C(═O)—, —NR⁷—, —CH—CH—, —C≡C—, a bivalent cyclic group, and their combinations. R⁷ represents an alkyl group having from 1 to 7 carbon atoms, or a hydrogen atom, preferably an alkyl group having from 1 to 4 carbon atoms, or a hydrogen atom, more preferably a methyl, an ethyl or a hydrogen atom, even more preferably a hydrogen atom.

The bivalent cyclic group for L¹, L² and L³ is preferably a 5-membered, 6-membered or 7-membered group, more preferably a 5-membered or 6-membered group, or even more preferably a 6-membered group. The ring in the cyclic group may be a condensed ring. However, a monocyclic ring is preferred to a condensed ring for it. The ring in the cyclic group may be any of an aromatic ring, an aliphatic ring, or a heterocyclic ring. Examples of the aromatic ring are a benzene ring and a naphthalene ring. An example of the aliphatic ring is a cyclohexane ring. Examples of the heterocyclic ring are a pyridine ring and a pyrimidine ring. Preferably, the cyclic group contains an aromatic ring or a heterocyclic ring. According to the invention, the divalent cyclic group is preferably a divalent linking group consisting of a cyclic structure (but the cyclic structure may have any substituent(s)), and the same will be applied to the later.

Of the bivalent cyclic group represented by L¹, L² or L³, the benzene ring-having cyclic group is preferably a 1,4-phenylene group. The naphthalene ring-having cyclic group is preferably a naphthalene-1,5-diyl group or a naphthalene-2,6-diyl group. The pyridine ring-having cyclic group is preferably a pyridine-2,5-diyl group. The pyrimidine ring-having cyclic group is preferably a pyrimidin-2,5-diyl group.

The bivalent cyclic group for L¹, L² and L³ may have a substituent. Examples of the substituent are a halogen atom, a cyano group, a nitro group, an alkyl group having from 1 to 16 carbon atoms, an alkenyl group having from 2 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms.

In the formula, L¹, L² and L³ are preferably a single bond, *—O—CO—, *—CO—O—, *—CH═CH—, *—C≡C—, *-“bivalent cyclic group”-, *—O—CO-“bivalent cyclic group”-, *—CO—O-“bivalent cyclic group”-, *—CH═CH-“bivalent cyclic group”-, *—C≡C-“bivalent cyclic group”-, *-“bivalent cyclic group”-O—CO—, *-“bivalent cyclic group”-CO—O—, *-“bivalent cyclic group”-CH═CH—, or *-“bivalent cyclic group”-C≡C—. More preferably, they are a single bond, *—CH═CH—, *—CH≡CH—“bivalent cyclic group”- or *—C≡C-“bivalent cyclic group”-, even more preferably a single bond. In the examples, “*” indicates the position at which the group bonds to the 6-membered ring of formula (IV) that contains Y¹¹, Y¹² and Y¹³.

In the formula, H¹, H² and H³ each independently represent the following formula (I-A) or (I-B):

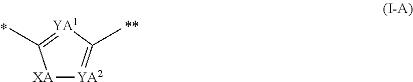

In formula (I-A), YA¹ and YA² each independently represent a methine group or a nitrogen atom;

XA represents an oxygen atom, a sulfur atom, a methylene group or an imino group;

* indicates the position at which the formula bonds to any of L¹ to L³; and

** indicates the position at which the formula bonds to any of R¹ to R³.

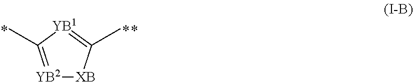

In formula (I-B), YB¹ and YB² each independently represent a methine group or a nitrogen atom;

XB represents an oxygen atom, a sulfur atom, a methylene group or an imino group;

* indicates the position at which the formula bonds to any of L¹ to L³; and

** indicates the position at which the formula bonds to any of R′ to R³.

In the formula, R¹, R² and R³ each independently represent the following formula (I-R):

*-(-L²¹-Q²)ₙ₁-L²²-L²³-Q¹ (I-R):

In formula (IV-R), * indicates the position at which the formula bonds to H¹, H² or H³ in formula (I).

L²¹ represents a single bond or a bivalent linking group. When L²¹ is a bivalent linking group, it is preferably selected from a group consisting of —O—, —S—, —C(═O)—, —NR⁷—, —CH═CH—, —C≡C—, and their combination. R⁷ represents an alkyl group having from 1 to 7 carbon atoms, or a hydrogen atom, preferably an alkyl group having from 1 to 4 carbon atoms, or a hydrogen atom, more preferably a methyl group, an ethyl group or a hydrogen atom, even more preferably a hydrogen atom.

In the formula, L²¹ is preferably a single bond, **—O—CO—, **—CO—O—, **—CH═CH— or **—C≡C— (in which ** indicates the left side of L²¹ in formula (I-R)). More preferably it is a single bond.

In the formula, Q² represents a bivalent cyclic linking group having at least one cyclic structure. The cyclic structure is preferably a 5-membered ring, a 6-membered ring, or a 7-membered ring, more preferably a 5-membered ring or a 6-membered ring, even more preferably a 6-membered ring. The cyclic structure may be a condensed ring. However, a monocyclic ring is preferred to a condensed ring for it. The ring in the cyclic ring may be any of an aromatic ring, an aliphatic ring, or a hetero ring. Examples of the aromatic ring are a benzene ring, a naphthalene ring, an anthracene ring, and a phenanthrene ring. An example of the aliphatic ring is a cyclohexane ring. Examples of the heterocyclic ring are a pyridine ring and a pyrimidine ring.

The benzene ring-having group for Q² is preferably a 1,4-phenylene group or a 1,3-phenylene group. The naphthalene ring-having group is preferably a naphthalene-1,4-diyl group, a naphthalene-1,5-diyl group, a naphthalene-1,6-diyl group, a naphthalene-2,5-diyl group, a naphthalene-2,6-diyl group, or a naphthalene-2,7-diyl group. The cyclohexane ring-having group is preferably a 1,4-cyclohexylene group. The pyridine ring-having group is preferably a pyridine-2,5-diyl group. The pyrimidine ring-having group is preferably a pyrimidin-2,5-diyl group. More preferably, Q² is a 1,4-phenylene group, a nephthalen-2,6-diyl group, or a 1,4-cyclohexylene group.

In the formula, Q² may have a substituent. Examples of the substituent are a halogen atom (e.g., fluorine atom, chlorine atom, bromine atom, iodine atom), a cyano group, a nitro group, an alkyl group having from 1 to 16 carbon atoms, an alkenyl group having from 1 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. The substituent is preferably a halogen atom, a cyano group, an alkyl group having from 1 to 6 carbon atoms, a halogen atom-substituted alkyl group having from 1 to 6 carbon atoms, more preferably a halogen atom, an alkyl group having from 1 to 4 carbon atoms, a halogen atom-substituted alkyl group having from 1 to 4 carbon atoms, even more preferably a halogen atom, an alkyl group having from 1 to 3 carbon atoms, or a trifluoromethyl group.

In the formula, n1 indicates an integer of from 0 to 4. n1 is preferably an integer of from 1 to 3, or more preferably 1 or 2.

In the formula, L²² represents **—O—, **—O—CO—, **—CO—O—, **—O—CO—O—, **—S—, **—NH—, **—SO₂—, **—CH₂—, **—CH═CH— or **—C≡C—, and “*” indicates the site bonding to the Q² side. Preferably, L²² represents **—O—, **—O—CO—, **—CO—O—, **—O—CO—O—, **—CH₂—, **—CH═CH— or **—C≡C—, or more preferably, L²² represents **—O—, **—O—CO—, **—CO—O—, **—O—CO—O—, or **—CH₂—. When the above group has a hydrogen atom, then the hydrogen atom may be substituted with a substituent. Examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms.

In the formula, L²³ represents a bivalent linking group selected from —O—, —S—, —C(═O)—, —SO₂—, —NH—, —CH₂—, —CH═CH— and —C≡C—, and a group formed by linking two or more of these. The hydrogen atom in —NH—, —CH₂— and —CH═CH— may be substituted with any other substituent. Examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms. The group substituted with the substituent improves the solubility of the compound of the formula (IV) in solvent, and therefore the composition can be readily prepared as a coating liquid.

In the formula, L²³ is preferably a linking group selected from a group consisting of —O—, —C(═O)—, —CH₂—, —CH═CH— and —C≡C—, and a group formed by linking two or more of these. L²³ preferably has from 1 to 20 carbon atoms, more preferably from 2 to 14 carbon atoms. Preferably, L²³ has from 1 to 16 (—CH₂—)'s, more preferably from 2 to 12 (—CH₂—)'s.

In the formula, Q¹ represents a polymerizable group or a hydrogen atom. In case where the compound of formula (IV) is used in producing optical films of which the retardation is required not to change by heat, such as optical compensatory films, Q¹ is preferably a polymerizable group. The polymerization for the group is preferably addition polymerization (including ring-cleavage polymerization) or polycondensation. In other words, the polymerizable group preferably has a functional group that enables addition polymerization or polycondensation. Examples of the polymerizable group are shown below.

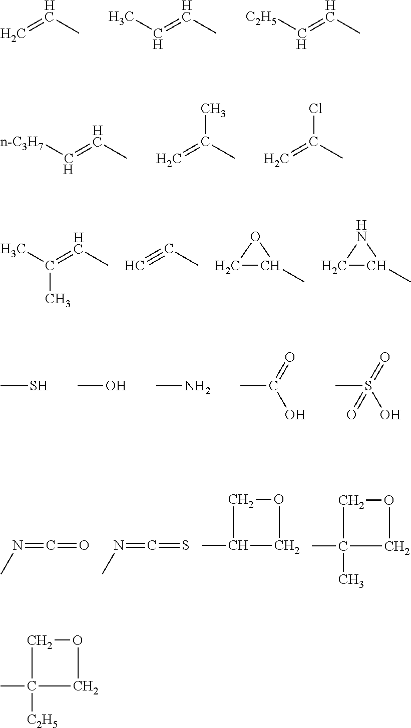

More preferably, the polymerizable group is addition-polymerizing functional group. The polymerizable group of the type is preferably a polymerizable ethylenic unsaturated group or a ring-cleavage polymerizable group.

Examples of the polymerizing ethylenic unsaturated group are the following (M-1) to (M-6):

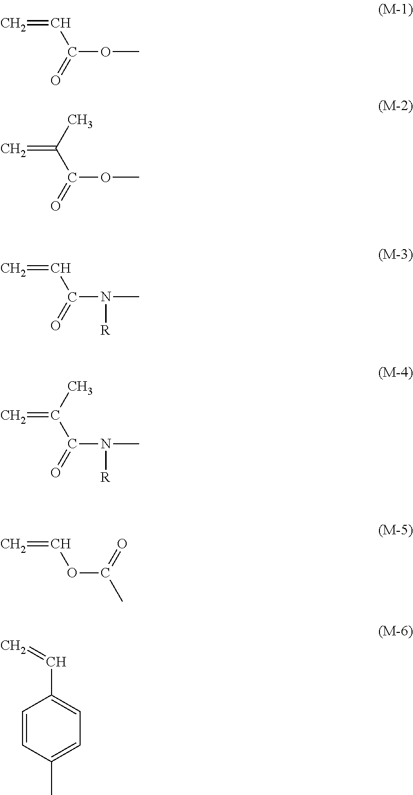

In formulae (M-3) and (M-4), R represents a hydrogen atom or an alkyl group. R is preferably a hydrogen atom or a methyl group.

Of formulae (M-1) to (M-6), preferred are formulae (M-1) and (M-2), and more preferred is formula (M-1).

The ring-cleavage polymerizable group is preferably a cyclic ether group, or more preferably an epoxy group or an oxetanyl group.

Among the compounds represented by formula (I), the compounds represented by formula (I′) are more preferable.

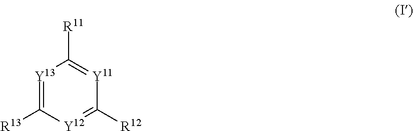

In the formula, Y¹¹, Y¹² and Y¹³ each independently represent a methine group or a nitrogen atom. Preferably, Y¹¹, Y¹² and Y¹³ are all methine groups, more preferably non-substituted methine groups.

In the formula, R¹¹, R¹² and R¹³ each independently represent the following formula represent the following formula (I′-A), (I′-B) or (I′-C). When the small wavelength dispersion of birefringence is needed, preferably, R¹¹, R¹² and R¹³ each represent the following formula (I′-A) or (I′-C), more preferably the following formula (IV′-A). Preferably, R¹¹, R¹² and R¹³ are same (R¹¹=R¹²=R¹³)

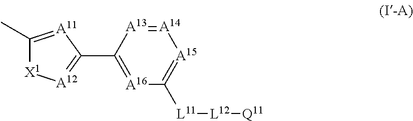

In formula (I′-A), A¹¹, A¹², A¹³, A¹⁴, A¹⁵ and A¹⁶ each independently represent a methine group or a nitrogen atom.

Preferably, at least one of A¹¹ and A¹² is a nitrogen atom; more preferably the two are both nitrogen atoms.

Preferably, at least three of A¹³, A¹⁴, A¹⁵ and A¹⁶ are methine groups; more preferably, all of them are methine groups. Non-substituted methine is more preferable.

Examples of the substituent that the methine group represented by A¹¹, A¹², A¹³, A¹⁴, A¹⁵ or A¹⁶ may have are a halogen atom (fluorine atom, chlorine atom, bromine atom, iodine atom) cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X¹ represents an oxygen atom, a sulfur atom, a methylene group or an imino group, but is preferably an oxygen atom.

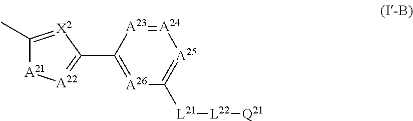

In formula (I′-B), A²¹, A²², A²³, A²⁴, A²⁵ and A²⁶ each independently represent a methine group or a nitrogen atom.

Preferably, at least either of A²¹ or A²² is a nitrogen atom; more preferably the two are both nitrogen atoms.

Preferably, at least three of A²³, A²⁴, A²⁵ and A²⁶ are methine groups; more preferably, all of them are methine groups.

Examples of the substituent that the methine group represented by A²³, A²⁴, A²⁵ or A²⁶ may have are a halogen atom (fluorine atom, chlorine atom, bromine atom, iodine atom), cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X² represents an oxygen atom, a sulfur atom, a methylene group or an imino group, but is preferably an oxygen atom.

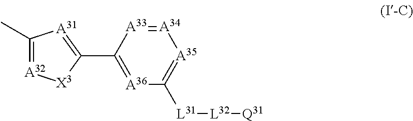

In formula (I′-C), A³¹, A³², A³³, A³⁴, A³⁵ and A³⁶ each independently represent a methine group or a nitrogen atom.

Preferably, at least either of A³¹ or A³² is a nitrogen atom; more preferably the two are both nitrogen atoms.

Preferably, at least three of A³³, A³⁴, A³⁵ and A³⁶ are methine groups; more preferably, all of them are methine groups.

When A³³, A³⁴, A³⁵ and A³⁶ are methine groups, the hydrogen atom of the methine group may be substituted with a substituent. Examples of the substituent that the methine group may have are a halogen atom (fluorine atom, chlorine atom, bromine atom, iodine atom), cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X³ represents an oxygen atom, a sulfur atom, a methylene group or an imino group, but is preferably an oxygen atom.

L¹¹ in formula (I′-A), L²¹ in formula (I′-B) and L³¹ in formula (I′-C) each independently represent —O—, —O—CO—, —CO—O—, —O—CO—O—, —S—, —NH—, —SO₂—, —CH₂—, —CH═CH— or —C≡C—; preferably —O—, —O—CO—, —CO—O—, —O—CO—O—, —CH₂—, —CH═CH— or —C≡C—; more preferably —O—, —O—CO—, —CO—O—, —O—CO—O— or —C≡C—. L¹¹ in formula (VI′-A) is especially preferable O—, —CO—O— or —C≡C— in terms of the small wavelength dispersion of birefringence; among these, —CO—O— is more preferable because the discotic nematic phase may be formed at a higher temperature. When above group has a hydrogen atom, then the hydrogen atom may be substituted with a substituent. Preferred examples of the substituent are a halogen atom, cyano, nitro, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms.

L¹² in formula (I′-A), L²² in formula (I′-B) and L³² in formula (I′-C) each independently represent a bivalent linking group selected from —O—, —S—, —C(═O)—, —SO₂—, —NH—, —CH₂—, —CH═CH— and —C≡C—, and a group formed by linking two or more of these. The hydrogen atom in —NH—, —CH₂— and —CH═CH— may be substituted with a substituent. Preferred examples of the substituent are a halogen atom, cyano, nitro, hydroxy, carboxyl, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. More preferred are a halogen atom, hydroxy and an alkyl group having from 1 to 6 carbon atoms; and especially preferred are a halogen atom, methyl and ethyl.

Preferably, L¹², L²² and L³² each independently represent a bivalent linking group selected from —O—, —C(═O)—, —CH₂—, —CH═CH— and —C≡C—, and a group formed by linking two or more of these.

Preferably, L¹², L²² and L³² each independently have from 1 to 20 carbon atoms, more preferably from 2 to 14 carbon atoms. Preferably, L¹², L²² and L³² each independently have from 1 to 16 (—CH₂—)'s, more preferably from 2 to 12 (—CH₂—)'s.

The number of carbon atoms constituting the L¹², L²² or L³² may influence both of the liquid crystal phase transition temperature and the solubility of the compound. Generally, the compound having the larger number of the carbon atoms has a lower phase transition temperature at which the phase transition from the discotic nematic phase (Nd phase) transits to the isotropic liquid occurs. Furthermore, generally, the solubility for solvent of the compound, having the larger number of the carbon atoms, is more improved.

Q¹¹ in formula (I′-A), Q²¹ in formula (I′-B) and Q³¹ in formula (I′-C) each independently represent a polymerizable group or a hydrogen atom. Preferably, Q¹¹, Q²¹ and Q³¹ each represent a polymerizable group. The polymerization for the group is preferably addition polymerization (including ring-cleavage polymerization) or polycondensation. In other words, the polymerizing group preferably has a functional group that enables addition polymerization or polycondensation. Examples of the polymerizable group are same as those exemplified above.

Examples of the compound represented by formula (I) include the compounds exemplified as “Compound 13”-“Compound 43”, described in JP-A-2006-76992, column 0052; and the compounds exemplified as “Compound 13”-“Compound 36”, described in JP-A-2007-2220, columns 0040-0063.

The compounds may be prepared according to any process. For example, the compounds may be prepared according to the method described in JP-A-2007-2220, columns 0064-0070.

The liquid-crystal phase that the liquid-crystal compound to be used in the invention expresses includes a columnar phase and a discotic nematic phase (ND phase). Of those liquid-crystal phases, preferred is a discotic nematic phase (ND phase) having a good mono-domain property.

Among the discotic liquid crystal compounds, the compounds forming the liquid crystal phase at a temperature of from 20 degrees Celsius to 300 degrees are preferable. The compounds forming the liquid crystal phase at a temperature of from 40 degrees Celsius to 280 degrees are more preferable, and the compounds forming the liquid crystal phase at a temperature of from 60 degrees Celsius to 250 degrees are even more preferable. The compound forming the liquid crystal phase at a temperature of 20 degrees Celsius to 300 degrees Celsius includes any compound of which the temperature range forming the liquid crystal phase resides including 20 degrees Celsius (for example the temperature range is from 10 degrees Celsius to 22 degrees Celsius), and includes also any compound of which the temperature range forming the liquid crystal phase resides including 300 degrees Celsius (for example, the temperature range is from 298 degrees Celsius to 310 degrees Celsius). The same will be applied to the temperature ranges of from 40 degrees Celsius to 280 degrees Celsius and of from 60 degrees Celsius to 250 degrees Celsius.

### (1)-2 Alignment Control Agent

In the invention, at least one alignment control agent is preferably used to bring the discotic liquid crystal into a desired alignment state. Alignment control agents may be used, which are localized at the interface with the alignment film and at the interface with air and control the alignment of the discotic liquid crystal in the vicinity of these interfaces. The optically anisotropic layer to be transferred in the invention must be formed into a reverse hybrid alignment. Thus, an alignment control agent is preferably used, which can control the discotic liquid crystal to be aligned at a high tilt angle (50° to 90°) in the vicinity of the interface with the alignment film. Alternatively, an alignment control agent may be used, which can control the discotic liquid crystal to be aligned at a low tilt angle (0° to 40°) in the vicinity of the interface with air. The former alignment control agent is particularly important since it also acts on the peelability of the optically anisotropic layer to be transferred from the alignment film at the interface between them.

Preferable examples of the usable alignment control agents are now described.

Alignment Control Agent at Interface with Alignment Layer:

Preferable examples of the alignment control agent at the interface with the alignment film include pyridinium salt compounds represented by the following formula (II). The pyridinium salt compounds represented by the formula (II), which are compounded to control the alignment of the discotic liquid crystal compound represented by the formula (I) at the interface with the alignment film, increase the tilt angle of each molecule of the discotic liquid crystal compound in the vicinity of the interface with the alignment film. From the viewpoint of maintaining a certain level of peelability, the pyridinium salt compounds represented by the formula (II) each preferably have no reactive group that may react with any component in the alignment film and form a covalent bond with the component. The reactive groups include a boronate group and a polymerizable group.

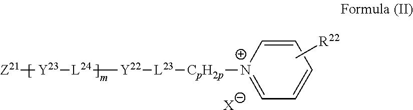

In the formula, L²³ and L²⁴ each represent a divalent linking group; R²² represents a hydrogen atom, an unsubstituted amino group, or a substituted amino group containing 1 to 20 carbon atoms; X represents an anion, Y²² and Y²³ each represent a divalent linking group having an optionally substituted five- or six-membered ring as a partial structure; Z²¹ represents a monovalent group selected from the group consisting of alkyl groups containing 13 to 20 carbon atoms, alkynyl groups containing 13 to 20 carbon atoms, and alkoxy groups containing 13 to 20 carbon atoms; p is an integer of 1 to 10; and m is 1 or 2.

In the formula, L²³ and L²⁴ represent a divalent linking group respectively.

L²³ is preferably a single bond, —O—, —O—CO—, —CO—O—, —C≡C—, —CH═CH—, —CH═N—, —N═CH—, —N═N—, —O-AL-O—, —O-AL-O—CO—, —O-AL-CO—O—, —CO—O-AL-O—, —CO—O-AL-CO—O—, —CO—O-AL-CO—O—, —O—CO-AL-O—, —O—CO-AL-O—CO— or —O—CO-AL-CO—O—, and AL is a C₁₋₁₀ alkylene group. L²³ is more preferably a single bond, —O—, —O-AL-O—, —O-AL-O—CO—, —O-AL-CO—O—, —CO—O-AL-O—, —CO—O-AL-O—CO—, —O—CO-AL-O—, —O—CO-AL-O—, —O—CO-AL-O—CO— or —O—CO-AL-CO—O—, even more preferably a single bond or —O—, or most preferably —O—.

L²⁴ is preferably a single bond, —O—, —O—CO—, —CO—O—, —C≡C—, —CH═CH—, —CH═N—, —N═CH— or —N═N—, or more preferably —O—CO— or —CO—O—. If n is equal to or larger than 2, a plurality of L²⁴ preferably represents —O—CO— or —CO—O— alternately.

R²² represents a hydrogen atom, unsubstituted amino group or substituted C₁₋₂₀ amino group.

If R²² is a dialkyl-substituted amino group, the two alkyls may connect to each other to form a nitrogen-containing heterocyclic ring. The nitrogen-containing heterocyclic ring is preferably a 5-membered or 6-membered ring. R²² preferably represents a hydrogen atom, non-substituted amino group or C₂₋₁₂ dialkyl substituted amino group, or even more preferably, a hydrogen atom, non-substituted amino group or C₂₋₈ dialkyl substituted amino group. If R²² is a non-substituted or substituted amino group, the 4-position of the pyridinium is preferably substituted.

R²² being an unsubstituted or substituted amino group preferably facilitates localization of the alignment control agent at the interface with the hydrophilic alignment film mainly containing PVA.

X represents an anion.

X preferably represents a monovalent anion. Examples of the anion include halide ion (such as fluorine ion, chlorine ion, bromine ion and iodide ion) and sulfonic acid ions (such as methane sulfonate ion, p-toluene sulfonate ion and benzene sulfonate ion).

The tilt angle may be controlled at the interface with the alignment film through appropriate selection of the anion X. For example, if the pyridinium salt compound has a sulfonate anion, particularly a p-toluene sulfonate or benzene sulfonate anion having an aromatic ring, the compound aligns the discotic liquid crystal at a relatively high tilt angle (for example, 70° to 90°) in the vicinity of the interface with the alignment film. In addition, if the pyridinium salt compound has a halide anion, particularly a bromide ion, the compound horizontally aligns the discotic liquid crystal in the vicinity of the interface with the alignment film. Combined use of these two pyridinium salt compounds enables the tilt angle to be controlled at 50° to 90° at the interface with the alignment film. Two or more pyridinium salt compounds having the same cation and different anions may also be used.

Y²² and Y²³ represent a divalent linking group having a 5-membered or 6-membered ring as a part structure respectively.

The 5-membered or 6-membered ring may have at least one substituent. Preferably, at least one of Y²² and Y²³ is a divalent linking group having a 5-membered or 6-membered ring with at least one substituent as a part structure. Preferably, Y²² and Y²³ each independently represent a divalent linking group having a 6-membered ring, which may have at least one substituent, as a part structure. The 6-membered ring includes an alicyclic ring, aromatic ring (benzene ring) and heterocyclic ring. Examples of the 6-membered alicyclic ring include a cyclohexane ring, cyclohexane ring and cyclohexadiene ring. Examples of the 6-membered heterocyclic ring include pyrane ring, dioxane ring, dithiane ring, thin ring, pyridine ring, piperidine ring, oxazine ring, morpholino ring, thiazine ring, pyridazine ring, pyrimidine ring, pyrazine ring, piperazine ring and triazine ring. Other 6-membered or 5-membered ring(s) may be condensed with the 6-membered ring.

Examples of the substituent include halogen atoms, cyano, C₁₋₁₂ alkyls and C₁₋₁₂ alkoxys. The alkyl or alkoxy may have at least one C₂₋₁₂ acyl or C₂₋₁₂ acyloxy. The substituent is preferably selected from C₁₋₁₂ (more preferably C₁₋₆, even more preferably C₁₋₃) alkyls. The 5-membered or 6-membered ring may have two or more substituents. For example, if Y²² and Y²³ are phenyls, they may have from 1 to 4 C₁₋₁₂ (more preferably C₁₋₆, or even more preferably C₁₋₃) alkyls.

In the formula, m is 1 or 2, or is preferably 2. If m is 2, plural Y²³ and L²⁴ may be same or different from each other respectively.

Z²¹ is a monovalent group selected from the group consisting of alkyl groups containing 13 to 20 carbon atoms, alkynyl groups containing 13 to 20 carbon atoms, and alkoxy groups containing 13 to 20 carbon atoms. The pyridinium salt compound represented by the formula (II) can be localized at the hydrophilic interface with the alignment film by the effect of the hydrophilic pyridinium salt site. The pyridinium salt compound, however, does not enter the alignment film and is localized only at the interface due to the repulsive force of the hydrophobic long-chain alkyl group contained in Z²¹. This facilitates separation of the optically anisotropic layer from the alignment film.

In the formula, p is an integer of from 1 to 10, or preferably 1 or 2. CₚH₂ₚ represents an alkylene chain which may have a branched structure. CₚH₂ₚ is preferably a linear alkylene chain (—(CH₂)ₚ—).

Among the compounds represented by formula (II), the compound represented by formula (II′) is preferable.

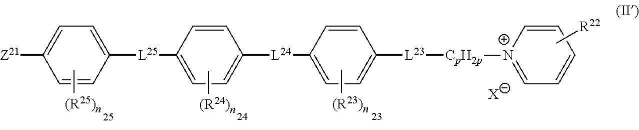

Among the symbols in the formula (II′), the same symbols have the same definition as those found in formula (II), and preferable examples thereof are same as those in formula (II). Preferably, L²⁴ and L²⁵ represent —O—CO— or —CO—O—; or more preferably, L²⁴ is —O—CO— and L²⁵ is —CO—O—.

R²³, R²⁴ and R²⁵ represent a C₁₋₁₂ (more preferably C₁₋₆, or even more preferably C₁₋₃) alkyl respectively. In the formula, n₂₃ is from 0 to 4, n₂₄ is from 1 to 4, and n₂₅ is from 0 to 4. Preferably, n₂₃ and n₂₅ are 0, and n₂₄ is from 1 to 4 (more preferably from 1 to 3).

Preferably, R³⁰ represents a C₁₋₁₂ (more preferably C₁₋₆, or even more preferably C₁₋₃) alkyl.

Specific examples of the compound represented by formula (II) include, but not limited to, compounds represented by formula (II-1) where anion is not depicted.

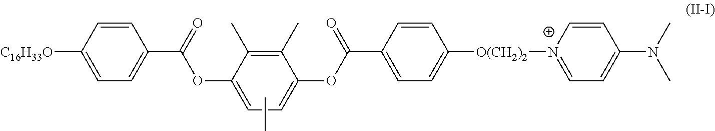

The pyridinium derivative of formula (II) is typically produced through alkylation (a Menschutkin reaction) of a pyridine ring.

Alignment Control Agent at Interface with Air:

In the invention, an alignment control agent at the interface with air may be used. An example of the alignment control agent is a compound containing a triazine ring group represented by the following formula (III). The compound containing the triazine ring group represented by the formula (III), which is mainly compounded to control alignment of the discotic liquid crystal compound represented by the formula (I) at the interface with air, decreases the tilt angle of molecules of the discotic liquid crystal compound in the vicinity of the interface with air.

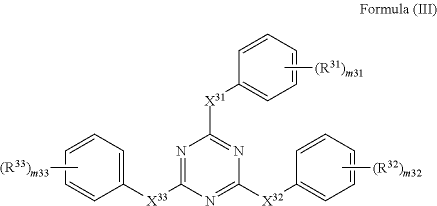

In the formula (III), R³¹, R³², and R³³ each represent an alkyl or alkoxy group having a terminal CF₃ group.

The alkyl group (including an alkyl group in the alkoxy group) may be a linear or branched alkyl group. In addition, two or more non-adjacent carbon atoms in the alkyl group (including the alkyl group in the alkoxy group) may be replaced with oxygen or sulfur atoms. Alternatively, one or more non-adjacent carbon atoms in the alkyl group may be replaced with oxygen atoms. The number of carbon atoms is preferably 4 to 20, more preferably 4 to 16, and most preferably 6 to 16.

The alkoxy group having a terminal CF₃ group contains hydrogen atoms part or all of which are replaced with fluorine atoms. Preferably, 50% or more of hydrogen atoms in the alkoxy group are replaced with fluorine atoms. More preferably, 60% or more of them are replaced therewith, and most preferably, 70% or more of them are replaced therewith.

Preferable examples of the R³¹, R³², and R³³ include the following alkoxy groups:

—O(CₙH₂ₙ)ₙ₁O(CₘH₂ₘ)ₘ₁—CₖF₂ₖ₊₁,

wherein n and m are each 1 to 3, n1 and m1 are each 1 to 3, and k is 1 to 10. More specific examples include the following alkoxy groups:

n-C₈F₁₇—(CH₂)₂—O—(CH₂)₂—O—;

n-C₆F₁₃—(CH₂)₂—O—(CH₂)₂—O—; and

n-C₄F₉—(CH₂)₂—O—(CH₂)₂—O—.

Each of X³¹, X³², and X³³ represents an alkylene group, —CO—, —NH—, —O—, —S—, —SO₂—, or a group containing at least two divalent linking groups selected therefrom. In particular, —NH— is preferred.

Each of m31, m32, and m33 is an integer of 1 to 5, and preferably 2.

The compound preferably has R³¹, R³², and R³³ at a para position and a meta position with respect to the substitution sites of X³¹, X³², and X³³, respectively.

Specific examples of the compound represented by formula (II) include the compounds described in [0187] to [0188] of Japanese Unexamined Patent Application Publication No. 2006-195140.

Fluorine polymers may be used as the alignment control agent at the interface with air. Examples of the usable fluorine polymers include fluorine polymers described in paragraphs [0023] to [0063] of Japanese Unexamined Patent Application Publication No. 2008-257205. Specifically, polymers including structural units represented by the following formula (A) and structural units derived from a monomer containing a fluoroaliphatic group can be used as the alignment control agent at the interface with air.

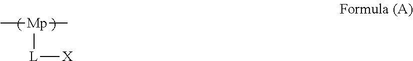

In formula (A), Mp represents a trivalent group occupying part or all of a polymer main chain, L represents a single bond or a divalent linking group, and X represents a substituted or unsubstituted condensed aromatic ring functional group.

An example of the structural unit derived from the monomer containing a fluoro aliphatic group is represented by formula (B):

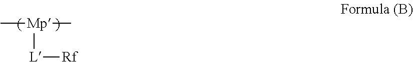

In the formula (B), Mp′ represents a trivalent group occupying part of a polymer main chain, L′ represents a single bonded or a divalent linking group, and Rf represents a substituent group containing at least one fluorine atom.

The polymers are described in detail in paragraphs [0023] to [0063] of Japanese Unexamined Patent Application Publication No. 2008-257205. Specifically, the following AD-4 and AD-13 can be exemplified.

| | Constitution | | Number | Molecular |
|---|---|---|---|---|
| | of repeating | Copolymer | average | weight |
| | unit of | proportion | molecular | distribution |
| | polymer | (mass %) | weight (Mn) | (Mw/Mn) |
| AD-4 | A-6/B-3 | 67.5/32.5 | 11100 | 2.03 |
| AD-13 | A-6/B-3/C-11 | 17.0/32.5/50.5 | 12700 | 2.18 |

A-6 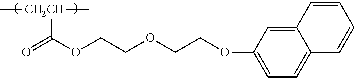
B-3 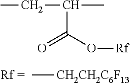
C-11

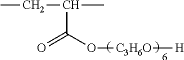

### (1)-3 Preparation of Composition

The optically anisotropic layer in the invention is formed from a composition containing discotic liquid crystal and one or more additive if required. The composition mainly contains a discotic liquid crystal compound. Although the proportion of the additive is not limited, the proportion of the pyridinium salt compound is preferably adjusted since it has influence not only on the alignment controllability but also on the peelability. To maintain both the alignment controllability and the peelability, the proportion of the compound represented by the formula (II) is preferably 1 to 5 parts by mass and is more preferably 1 to 3 parts by mass to 100 parts by mass of the discotic liquid crystal. The proportion of the compound containing the triazine ring group represented by formula (III) is preferably 0.2 to 1.0 parts by mass, and is more preferably 0.2 to 0.4 parts by mass to 100 parts by mass of the discotic liquid crystal.

The composition can be prepared in a form of a coating solution. Organic solvents are preferably used for preparation of the coating solution. Examples of the organic solvents include amides (for example, N,N-dimethylformamide), sulfoxides (for example, dimethyl sulfoxide), heterocyclic compounds (for example, pyridine), hydrocarbons (for example, benzene and hexane), alkyl halides (for example, chloroform, dichloromethane, and tetrachloroethane), esters (for example, methyl acetate and butyl acetate), ketones (for example, acetone and methyl ethyl ketone), and ethers (for example, tetrahydrofuran and 1,2-dimethoxyethane). In particular, alkyl halides and ketones are preferred. The organic solvents may be used alone or in combination. The surface tension of the coating solution is preferably 25 mN/m or less (more preferably, 22 mN/m or less) to form a uniform, optically anisotropic layer.

The composition is preferably curable, and preferably contains a polymerization initiator in this embodiment. Although the polymerization initiator may be a thermal polymerization initiator or a photopolymerization initiator, the photopolymerization initiator is preferred from the viewpoint of ease in control, for example. Preferred examples of the photopolymerization initiator, which generates radicals by the effect of light, include α-carbonyl compounds (described in U.S. Pat. Nos. 2,367,661 and 2,367,670), acyloin ethers (described in U.S. Pat. No. 2,448,828), α-hydrocarbon-substituted aromatic acyloin compounds (described in U.S. Pat. No. 2,722,512), polynuclear quinone compounds (described in U.S. Pat. Nos. 3,046,127 and 2,951,758), a combination of triaryl imidazole dimer and p-aminophenyl ketone (described in U.S. Pat. No. 3,549,367), acridine and phenazine compounds (described in Japanese Unexamined Patent Application Publication No. 60-105667 and U.S. Pat. No. 4,239,850), oxadiazole compounds (described in U.S. Pat. No. 4,212,970), acetophenone compounds, benzoin ether compounds, benzyl compounds, benzophenone compounds, and thioxanthone compounds.

A sensitizer may be contained in addition to the polymerization initiator in order to improve the sensitivity. Examples of the sensitizer include n-butylamine, triethylamine, tri-n-butyl phosphine, and thioxanthone. A combination of various polymerization initiators may be used, and the total proportion of the polymerization initiators is preferably 0.01 to 20 percent by mass of the solid content of the coating solution, and more preferably 0.5 to 5 percent by mass thereof. Ultraviolet rays are preferably used for light irradiation for polymerization of the liquid crystal compound.

The composition may contain a nonliquid-crystalline polymerizable monomer in addition to the polymerizable liquid crystal compound. The polymerizable monomer preferably includes a compound containing a vinyl group, a vinyloxy group, an acryloyl group, or a methacryloyl group. A multifunctional monomer having the number of polymerizable functional groups of two or more, for example, ethylene oxide-modified trimethylolpropane acrylate, is preferably used to improve durability. The content of the nonliquid-crystalline polymerizable monomer (nonliquid-crystalline component) is not more than 15 percent by mass and is preferably about 0 to 10 percent by mass of the content of the liquid crystal compound.

### (1)-4 Formation of Optically Anisotropic Layer

An exemplary method of forming the optically anisotropic layer is now described.

The composition prepared in a form of a coating solution is applied on a rubbed surface of an alignment film. The coating process includes known coating processes such as curtain coating, dip coating, spin coating, print coating, spray coating, slot coating, roll coating, slide coating, blade coating, gravure coating, and wire bar coating.

The coating of the composition is dried to bring the molecules of the discotic liquid crystal compound into a desired alignment state. Here, the coating is preferably heated. In particular, if the coating is heated at 80° C. to 90° C., the molecules of the discotic liquid crystal compound can be brought into a reverse hybrid alignment state while their slow axes are oriented orthogonal to a rubbing direction, leading to a stable alignment state. If the coating is heated at less than 80° C., the molecular alignment is disordered. If the coating is heated at more than 90° C., the molecules exhibit reverse hybrid alignment whereas their slow axes tends to be oriented parallel to the rubbing direction. The coating is preferably heated at 80° C. to 90° C. for about 60 sec to 300 sec, and more preferably for about 90 sec to 300 sec.

The molecules of the discotic liquid crystal compound are oriented into a desired alignment state, and the molecules are then cured through polymerization to fix the alignment state, resulting in formation of the optically anisotropic layer. The molecules are cured through irradiation with light including X-rays, electron beams, ultraviolet rays, visible light, and infrared rays (thermic rays). In particular, ultraviolet rays are preferred. Preferred examples of the light source of ultraviolet rays include low-pressure mercury lamps (bactericidal lamps, fluorescent chemical lamps, and black lights), high-pressure discharge lamps (high-pressure mercury lamps and metal halide lamps), and short-arc discharge lamps (ultra-high-pressure mercury lamps, xenon lamps, and mercury xenon lamps). Light exposure is preferably about 50 to 6000 mJ/cm², and is more preferably about 100 to 2000 mJ/cm². The molecules are preferably irradiated with light while being heated for achieving adequate alignment control in a short time. The heating temperature is preferably about 40° C. to 140° C.

The thickness of the optically anisotropic layer formed in this way is preferably, but not limited to, 0.1 μm to 10 μm, and more preferably 0.5 μm to 5 μm.

### (2) Alignment Film

In the invention, modified or unmodified polyvinyl alcohol is used as a material of the alignment film. The material can be selected not only from known materials as vertical alignment films but also from known materials for horizontal alignment films. For example, modified or unmodified polyvinyl alcohol is preferred. The modified polyvinyl alcohol described in paragraphs to of Japanese Patent No. 3907735 can also be used. A modified PVA having a polymerizable group may also be used. The percentage of the polymerizable group in the modified PVA has influence on separation between the alignment film 22 and the optically anisotropic layer 14′ to be transferred. The percentage of the polymerizable group is preferably 0% from the viewpoint of the peelability. In contrast, excessively high peelability tends to cause peeling of the untransferred optically anisotropic layer during storage and/or conveyance; hence, a certain level of adhesion is required from the viewpoint of productivity. As a result, the percentage of the polymerizable group in the untransferred optically anisotropic layer is preferably 0.1% to 2.0% in light of the peelability and productivity.

The alignment film usable in the invention has a rubbed surface. The surface of the alignment film in the invention can be rubbed with a common rubbing process. For example, the surface of the alignment film can be rubbed with a rubbing roll. In an embodiment where the alignment film is continuously formed on a support composed of an elongated polymer film, the direction of rubbing treatment (rubbing direction) preferably corresponds to the longitudinal direction of the polymer film from the viewpoint of suitability for production.

### (3) Substrate and Provisional Substrate

There is no restriction on the substrate and on the provisional substrate. In addition, the substrate and the provisional substrate may each have a rolled-up form of a long film, or, for example, have a rectangular sheet form corresponding to a size of end products. Preferably, the rolled-up long polymer film is used in the provisional substrate and the substrate, the transferring material and the optical film are each continuously formed in an elongated shape, and then cut into a required size.

The provisional substrate is separated from the optically anisotropic layer after the transfer; hence, it can be selected from various materials having different properties, such as transparent films, opaque films, metal sheets, and glass sheets. If adhesion between the provisional substrate and the alignment film is low due to low affinity therebetween, adequate separation between the optically anisotropic layer and the alignment film may not be achieved at the interface therebetween. In such a case, the surface of the provisional substrate may be surface-treated to improve adhesion to the alignment film. If the alignment film is composed of a hydrophilic material such as PVA, the surface of the provisional substrate is preferably subjected to hydrophilic treatment so that the water contact angle is adjusted to be within the range described above. Examples of the hydrophilic treatment include saponification treatment and corona treatment. The water contact angle can be measured with an automatic contact angle meter DM500 (available from Kyowa Interface Science Co., Ltd.).

The substrate is eventually built in the liquid crystal display together with the optically anisotropic layer; hence, the substrate preferably has optical characteristics that do not impair the characteristics of the display. An example of the substrate is a transparent film mainly containing a polymer, specifically a film having a light transmittance of 80% or more. In addition, the film preferably has a small thickness, for example, 20 μm to 70 μm. Examples of the films usable as a substrate include cellulose acylate, polycarbonate, polysulfone, polyether sulfone, polyacrylate, polymethacrylate, and cyclic olefin films. The cellulose acylate film is preferred, and the cellulose acetate film is more preferred.

[Cellulose Acylate Material]

The cellulose materials for the cellulose acylate film used in the invention include cotton linter and wood pulp (deciduous pulp and coniferous pulp). Cellulose acylate produced from any cellulose material can be used.

A mixture of the materials may be used in some cases. Such cellulose materials are described in detail, for example, by Marusawa and Uda “Plastic Zairyo Kouza (Plastic Material Course) (17): Sen-i-kei Jusi (Cellulose Resin)” published in 1970 by Nikkan Kogyo Shimbun Ltd., and Hatsumeikyoukai Kokaigiho (Journal of Technical Disclosure), Kogi No. 2001-1745, pp. 7-8, published on Mar. 15, 2001 by Japan Institute of Invention and Innovation. Such described cellulose materials can be used for the retardation film in the invention without limitation.

### [Degree of Substitution of Cellulose Acylate]

Cellulose acylate is formed through acylation of hydroxyl groups of cellulose, where any acyl group, from the acetyl group containing two carbon atoms to an acyl group containing 22 carbon atoms, can be used as a substituent.

There is no restriction on the degree of substitution of the acyl groups for the hydroxyl groups of cellulose in the cellulose acylate used in the invention.

The degree of substitution of the cellulose acylate in the invention can be determined through measurement of the uniting level of an acetic acid and/or a fatty acid containing 3 to 22 carbon atoms, which is to be substituted for a hydroxyl group of cellulose, and through calculation based on such observed values.

The uniting level can be measured in accordance with ASTM D-817-91.

The degree of substitution is 3 at 100% substitution of the hydroxyl groups of cellulose.

In the acetic acid and/or the fatty acid containing 3 to 22 carbon atoms to be substituted for a hydroxyl group of cellulose, the acyl group containing 2 to 22 carbon atoms may be any aliphatic or allyl group, and may be a single group or a mixture of two or more groups. Examples of the acyl group containing 2 to 22 carbon atoms include alkylcarbonyl esters and alkenylcarbonyl esters of cellulose, aromatic carbonyl esters, and aromatic alkyl carbonyl esters, which may each have a substituted group. Preferred acyl groups include acetyl groups, propionyl groups, butanoyl groups, heptanoyl groups, hexanoyl groups, octanoyl groups, decanoyl groups, dodecanoyl groups, tridecanoyl groups, tetradecanoyl groups, hexadecanoyl groups, octadecanoyl groups, isobutanoyl groups, tert-butanoyl groups, cyclohexane carbonyl groups, oleoyl groups, benzoyl groups, naphthylcarbonyl groups, and cinnamoyl groups. Among them, preferred are acetyl groups, propionyl groups, butanoyl groups, dodecanoyl groups, octadecanoyl groups, tert-butanoyl groups, oleoyl groups, benzoyl groups, naphthylcarbonyl groups, and cinnamoyl groups, and more preferred are acetyl groups, propionyl groups, and butanoyl groups.

### [Degree of Polymerization of Cellulose Acylate]

The degree of polymerization of cellulose acylate preferably used in the invention is 180 to 700 in the viscosity average of polymerization. For cellulose acetate, the degree of polymerization is preferably 180 to 550, more preferably 180 to 400, and most preferably 180 to 350. An excessively high degree of polymerization of cellulose acylate leads to an increase in viscosity of a dope solution of cellulose acylate, which may disturb smooth film formation by casting. In contrast, an excessively low degree of polymerization thereof may reduce the strength of a resultant film. The viscosity average of polymerization can be measured by the intrinsic viscosity method by Uda et al. (Uda and Saito, Sen'i Gakkaishi, 18, 1, pp. 105-120 (1962)). Such measurement is described in detail in Japanese Unexamined Patent Application Publication No. 9-95538.

The molecular weight distribution of cellulose acylate preferably used in the invention is evaluated by gel-permeation chromatography, where the polydispersity index Mw/Mn (Mw represents the mass average molecular weight, and Mn represents the number average molecular weight) is preferably small, i.e., the molecular weight distribution is preferably narrow. The specific value of Mw/Mn is preferably 1.0 to 4.0, more preferably 1.0 to 3.5, and most preferably 1.0 to 3.0.

Removal of the low-molecular weight components from cellulose acylate usefully reduces the viscosity compared with normal cellulose acylate though it increases the average molecular weight (degree of polymerization).

For example, such cellulose acylate having a small amount of low-molecular weight components can be produced by removing low-molecular weight components from cellulose acylate synthesized in a typical manner.

The low-molecular weight components can be removed by washing the cellulose acylate with an appropriate organic solvent. For manufacturing the cellulose acylate containing small amounts of low-molecular weight components, the amount of a sulfuric acid catalyst in an acetification reaction is preferably adjusted to be 0.5 to 25 parts by mass to 100 parts by mass of cellulose. The amount of the sulfuric acid catalyst is adjusted to be within the above-described range, enabling synthesis of cellulose acylate that is further preferable in terms of molecular weight distribution (has uniform molecular weight distribution).

During manufacture of the cellulose acylate film of the invention, the moisture content of used cellulose acylate is preferably 2 mass % or less, more preferably 1 mass % or less, and most preferably 0.7 mass % or less. In general, cellulose acylate contains water in an amount of 2.5 to 5 mass %. In the invention, cellulose acylate must be dried to adjust its moisture content to be within the above-described range. Any drying process enabling the target moisture content can be used without limitation.

The material cotton for and the synthesizing process of cellulose acylate used in the invention are described in detail in Hatsumeikyoukai Kokaigiho (Journal of Technical Disclosure), Kogi No. 2001-1745, pp. 7-12, published on Mar. 15, 2001 by Japan Institute of Invention and Innovation.

Cellulose acylates used in the invention may include a single cellulose acylate or a mixture of two or more cellulose acylates in one layer, each cellulose acylate having the substituent, the degree of substitution, the degree of polymerization, and the molecular weight distribution described above.

### [Additive for Cellulose Acylate Film]

The cellulose acylate solution for producing the cellulose acylate film of the invention can contain various additives (for example, a compound reducing optical anisotropy, a compound developing optical anisotropy, a wavelength dispersion adjuster, a UV inhibitor, a plasticizer, a deterioration inhibitor, fine particles, and an optical characteristic adjuster), which are added depending on application in each preparation step.

Although the additives can be added at any timing in a dope preparation process, a step, in which the additives are added to finish dope preparation, may be employed as a final preparation step of the dope preparation process.

### [Manufacturing Process of Cellulose Acylate Film]

The cellulose acylate film used in the invention can be manufactured by the method in accordance with Japanese Unexamined Patent Application Publication No. 2006-305751.

A retardation film used as the substrate preferably contributes to optical compensation for the liquid crystal display together with the optically anisotropic layer. If the substrate has an Rth within the range defined in the invention, grayscale inversion can be preferably reduced in both horizontal and vertical directions.

The substrate may be a polarizing film. Examples of the polarizing film include an iodine-containing polarizing film, a dichroic dye-containing polarizing film, and a polyene-containing polarizing film, any of which may be used in the invention. The iodine-containing polarizing film and the dye-containing polarizing film are typically produced with a polyvinyl alcohol film. The thickness of the polarizing film is in general about 20 μm to 30 μm. A protective film is preferably provided on the back (a side opposite to a surface onto which the optically anisotropic layer is to be transferred) of the polarizing film. Examples of the protective film are the same as examples of the films usable as the substrate.

### (5) Material for Adhesion Layer

Examples of the material usable for formation of the adhesion layer include common adhesive agents such as acrylic, vinyl acetate, polyamide, vinyl chloride, chloroprene rubber, epoxy, and isocyanate adhesive agents, in addition to the UV curable composition. The UV curable composition preferably includes epoxy acrylate, urethane acrylate, and/or cyanoacrylate, for example. Alternatively, the adhesion layer may be composed of a material that is generally classified as a tacking agent different from the curable composition. The thickness of the adhesion layer is typically, but not limited to, 1 μm to 30 μm.

### (4) Liquid Crystal Display

The present invention also relates to a liquid crystal display having an optical film of the invention. The optical film of the invention is suitable for optical compensation for TN liquid crystal displays. Hence, a preferred embodiment of the invention relates to a TN liquid crystal display. The TN-mode liquid crystal cell and the TN liquid crystal display have been generally known. The optical film of the invention is preferably disposed with the optically anisotropic layer on a side close to the liquid crystal cell. The optically anisotropic layer used for optical compensation may be microscopically disordered, which causes a reduction in front contrast of the liquid crystal display, for example. The optically anisotropic layer of the optical film of the invention has an extremely small amount of microscopic orientation deviation. Consequently, according to the invention, sufficient optical compensation can be achieved by the optical film of the invention without a reduction in front contrast of the liquid crystal display.

In addition, the optical film of the invention has an extremely small thickness, or a total thickness of 0.1 μm to 70 μm, and is suitable for thin display panels such as tablet PCs, mobile phones, and notebook PCs.

### 4. Measuring Techniques of Characteristics

In this description, Re(λ) and Rth(λ) are retardation (nm) in plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments). The selection of the measurement wavelength may be conducted according to the manual-exchange of the wavelength-selective-filter or according to the exchange of the measurement value by the program.

The measuring techniques are partially used for measurement of the average tilt angle, described later, on a side close to the alignment film of the discotic liquid crystal molecules in the optically anisotropic layer, and measurement of the average tilt angle on a side opposite thereto.

Rth(λ) is calculated by KOBRA 21ADH or WR on the basis of the six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane), a value of hypothetical mean refractive index, and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to formulae (A) and (III):

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad ( A )$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

Rth={(nx+ny)/2−nz}×d (III):

In the formula, nx represents a refractive index in the in-plane slow axis direction; ny represents a refractive index in the in-plane direction perpendicular to nx; and nz represents a refractive index in the direction perpendicular to nx and ny. And “d” is a thickness of the film.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59). KOBRA 21ADH or WR calculates nx, ny and nz, upon enter of the hypothetical values of these mean refractive indices and the film thickness. On the basis of thus-calculated nx, ny and nz, Nz=(nx−nz)/(nx−ny) is further calculated.

### (Measurement of Tilt Angle)

In an optically anisotropic layer containing an aligned discotic liquid crystal compound, it is difficult to directly and accurately measure the tilt angle θ1 (defined by a physical symmetric axis of the discotic liquid crystal compound and a boundary surface of the optically anisotropic layer) at one surface of the optically anisotropic layer and a tilt angle θ2 at the other surface thereof. Therefore, in this description, θ1 and θ2 are calculated as follows: This method could not accurately express the actual alignment state, but may be helpful as a means for indicating the relative relationship of some optical characteristics of an optical film.

In this method, the following two points are assumed for facilitating the calculation, and the tilt angles at two interfaces of an optically-anisotropic film are determined.

1. It is assumed that an optically-anisotropic film is a multi-layered structure that comprises a layer containing discotic or rod-like compound(s). It is further assumed that the minimum unit layer constituting the structure (on the assumption that the tilt angle of the liquid crystal compound molecule is uniform inside the layer) is an optically-monoaxial layer.

2. It is assumed that the tilt angle in each layer varies monotonously as a linear function in the direction of the thickness of an optically-anisotropic layer.

A concrete method for calculation is as follows:

(1) In a plane in which the tilt angle in each layer monotonously varies as a linear function in the direction of the thickness of an optically-anisotropic film, the incident angle of light to be applied to the optically-anisotropic film is varied, and the retardation is measured at three or more angles. For simplifying the measurement and the calculation, it is desirable that the retardation is measured at three angles of −40°, 0° and +40° relative to the normal direction to the optically-anisotropic film of being at an angle of 0°. For the measurement, for example, used are KOBRA-21ADH and KOBRA-WR (by Oji Scientific Instruments), and transmission ellipsometers AEP-100 (by Shimadzu), M150 and M520 (by Nippon Bunko) and ABR10A (by Uniopto).

(2) In the above model, the refractive index of each layer for normal light is represented by n0; the refractive index thereof for abnormal light is by ne (ne is the same in all layers as well as n0); and the overall thickness of the multi-layer structure is represented by d. On the assumption that the tilting direction in each layer and the monoaxial optical axis direction of the layer are the same, the tilt angle θ1 in one face of the optically-anisotropic layer and the tilt angle θ2 in the other face thereof are fitted as variables in order that the calculated data of the angle dependence of the retardation of the optically-anisotropic layer could be the same as the found data thereof, and θ1 and θ2 are thus calculated.

In this, n0 and ne may be those known in literature and catalogues. When they are unknown, they may be measured with an Abbe's refractiometer. The thickness of the optically-anisotropic film may be measured with an optical interference thickness gauge or on a photograph showing the cross section of the layer taken by a scanning electronic microscope.

### EXAMPLES

The invention is described in more detail with reference to the following Examples. In the following Examples, the material used, its amount and ratio, the details of the treatment and the treatment process may be suitably modified or changed not overstepping the sprit and the scope of the invention. Accordingly, the invention should not be limitatively interpreted by the Examples mentioned below.

### 1. Production of Transferring Material

### (1) Preparation of Provisional Substrate

TD 80 (available from FUJIFILM Corporation) was used as provisional substrates. A water contact angle on the surface of the film for each provisional substrate was measured after saponification of the surface with a 1.5N sodium hydroxide solution. The results are shown in the table below.

### (2) Formation of Alignment Film

A coating solution for alignment layers, having the following composition, was continuously applied with a #14 wire bar on the saponified surface of the film for the provisional support prepared as above. The coating was then dried by hot air at 60° C. for 60 sec and then at 100° C. for 120 sec to yield an alignment film.

Composition of coating solution for alignment film

| | | |
|---|---|---|
| Modified polyvinyl alcohol described below | 10 | parts by mass |
| Water | 371 | parts by mass |
| Methanol | 119 | parts by mass |
| Glutaraldehyde | 0.5 | parts by mass |

PVA

Modified polyvinyl alcohol

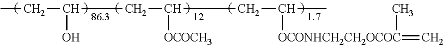

The surface of the resultant alignment film was rubbed along the longitudinal direction of the film.

Modified polyvinyl alcohols having different proportions of polymerizable groups as shown in the table below were prepared to form various alignment layers in the same way as above.

The table below shows the proportion of the polymerizable group of the modified polyvinyl alcohol used in each Example. The proportion of the polymerizable group corresponds to a numeral that is appended in the parenthesis in the above-described formula and that indicates a molar ratio of the monomer having a polymerizable group.

### (3) Formation of Untransferred Optically Anisotropic Layer

A coating solution for an untransferred optically anisotropic layer having a composition described below was applied into a coating density of 4 mL/m² with a bar coater. The coating was then heated for about 120 sec at a temperature shown in the table described below to align the liquid crystal compound. While the temperature was kept, the liquid crystal compound was irradiated with ultraviolet rays at an illuminance of 600 mW/cm² for 4 sec by an ultraviolet irradiator (UV lamp: output power 160 W/cm, emission wavelength 1.6 m), so that the liquid crystal compound was fixed into such alignment through a crosslinking reaction. The coating was then cooled to ambient temperature. The film was then wound into a cylindrical shape, resulting in formation of a rolled transferring material. (Composition of coating solution for untransferred optically anisotropic layer)

Composition of coating solution for untransferred optically
anisotropic layer (parts by mass)

| Discotic liquid crystal compound (1) described below | 100.0 | parts by mass |
|---|---|---|
| Pyridinium salt compound shown in the table below | parts by mass as shown in the table below | |
| Alignment control agent at interface with air shown in the table below | parts by mass as shown in the table below | |
| Photopolymerization initiator (IIRGACURE 907, available from Ciba Geigy) | 3.0 | parts by mass |
| Sensitizer (KAYACURE DETX, available from NIPPON KAYAKU CO., LTD.) | 1.0 | parts by mass |
| Methyl ethyl ketone | 341.8 | parts by mass |

Discotic liquid crystal compound (1) 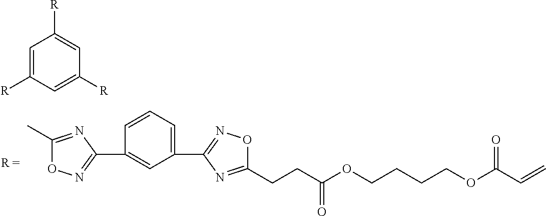
Pyridinium salt compound 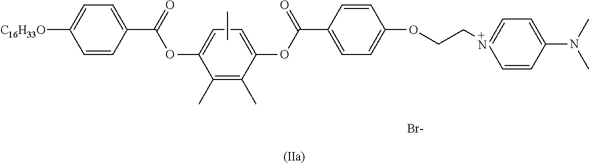 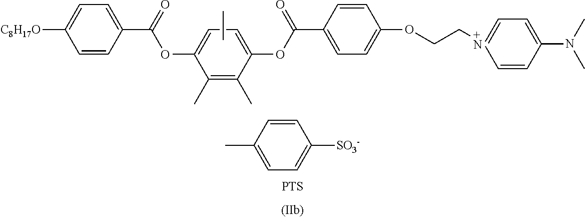 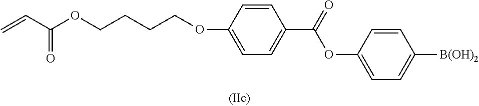 [SMILES: C=CC(=O)OCCCCOc1ccc(C(=O)Oc2ccc(B(O)O)cc2)cc1] 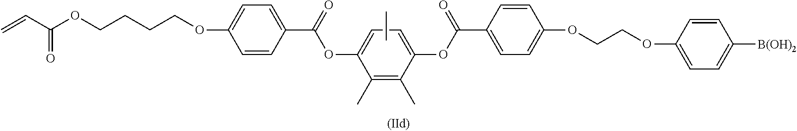 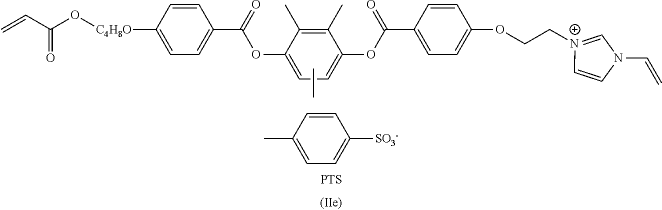 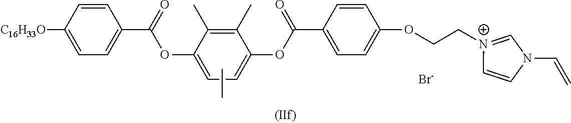
Alignment control agent at interface with air
AD-4 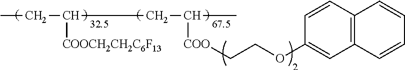
AD-13

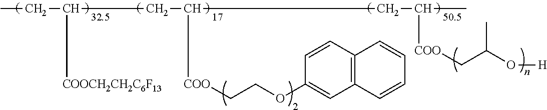

### (4) Evaluation of Transferring Material Evaluation of Alignment Mode

With each of the untransferred optically anisotropic layers of the resultant transferring materials, the tilt angle of the molecule of the discotic liquid crystal compound was measured at the interface with the alignment film and at the interface with air in accordance with the above-described technique with KOBRA-21ADH (available from Oji Scientific Instruments). The results are shown in the table below.

### Evaluation of Peelability:

A cross-cut tape peeling test was conducted in accordance with JIS D0202-1988. A cellophane tape (CT24 available from Nichiban Co., Ltd.) was tightly attached to the film with a rod, and was then separated from the film. The peelability was expressed with the number of separated squares among total 100 squares, and evaluated in accordance with the following criterion.

Excellent: 51 or more

Good: 26 to 50

Moderate: 1 to 25

Bad: 0

### 2. Production of Optical Film

### (1) Preparation of Substrate

Various substrates as shown in the table below were prepared for optical films. The material, optical characteristics, and thickness of each substrate are shown in the table below.

A UV curable resin was applied onto the surface of each substrate and dried into an adhesion precursor layer to produce a laminate.

### (1)-1 Formation of Support 1

A cellulose acetate solution containing an oligomer in an amount described below was prepared, the oligomer having a composition and a number average molecular weight as described below.

Composition of cellulose acetate solution

| | |
|---|---|
| Cellulose acetate having average | 100.0 parts by mass |
| degree of substitution of 2.86 | |
| Methylene chloride (first solvent) | 475.9 parts by mass |
| Methanol (second solvent) | 113.0 parts by mass |
| Butanol (third solvent) | 5.9 parts by mass |
| Silica particle having mean particle size | 0.13 parts by mass |
| of 16 nm (AEROSIL R972, available | |
| from Nippon Aerosil Co., Ltd. ) | |
| Oligomer (having a composition | 10 parts by mass |
| shown in the below) | |

The prepared solution was casted under a PIT draw condition shown in the table below onto a mirror-finished stainless-steel support, which was a drum 3 m in diameter, through a casting geeser.

The following table also shows a formation condition and optical characteristics of the polymer film. In the table, Re is expressed assuming that a plus direction is orthogonal to a cast direction.

TABLE 1

| | | | | |
|---|---|---|---|---|
| Recipe | Oligomer | Dicarboxylic | TPA | 50 |
| | composition | acid unit | PA | 0 |
| | | *1 | AA | 50 |
| | | | SA | 0 |
| | | Diol unit *2 | EG | 50 |
| | | | PG | 50 |

| | | Molecular weight*3 | 1000 |
|---|---|---|---|
| | | Amount (parts by mass) | 10 |
| Physical | Re (nm) | | −4 |
| properties | Rth (nm) | | 35 |
| | Thickness (μm) | | 38 |
| Process | Stretching | PIT draw (%) | 104 |

*1: “TPA” refers to terephthalic acid, “PA” refers to phthalic acid, “AA” refers to adipic acid, and “SA” refers to succinic acid, of which the molar ratios are shown in the table.
*2: “EG” refers to ethanediol, and “PG” refers to 1,3-propandiol, of which the molar ratios are shown in the table.
*3: Number average molecular weight.

### (1)-2 Preparation of Support 2

Support 2 having an Rth of 60 nm was prepared as in support 1 except that the amount of oligomer was 17 parts by mass.

### (1)-3 Preparation of Support 3

Support 3 having an Rth of 80 nm was prepared as in support 1 except that the amount of oligomer was 23 parts by mass.

### (1)-4 Preparation of Support

The following ingredients, which are the matting agent dispersion, additive agents, and cellulose acetate having acetyl substitution of 2.88 were put into a mixing tank, while being stirred to dissolve the ingredients. The solution was adjusted so that the concentration of the cellulose acetate was 17%, and thereby cellulose acylate dope was prepared.

| | |
|---|---|
| Methylene chloride (first solvent) | 92 (parts by mass) |
| Methanol (second solvent) | 8 (parts by mass) |

Further, a matting agent described below was contained in an amount of 3.6 parts by weight relative to 100 parts by weight of the cellulose acetate. Additive agents described below were contained in an amount of described below ratio relative 100 parts by weight of the cellulose acetate.

| (matting agent dispersion) | | |
|---|---|---|
| Silica particle dispersion (average grain | 0.7 | parts by mass |
| diameter: 16 nm) | | |
| Methylene chloride (first solvent) | 72.4 | parts by mass |
| Methanol (second solvent) | 6.5 | parts by mass |
| The dope | 17.3 | parts by mass |
| (additive agents) | | |
| Plasticizer P-1 | 12.0 | parts by mass |
| Ultraviolet absorber UV-1 | 1.8 | parts by mass |
| Ultraviolet absorber UV-2 | 0.8 | parts by mass |

The plasticizer P-1 was mixture of triphenylphosphate (TPP)/biphenyldiphenylphospate (BDP) = 2/1.
Ultraviolet absorber UV-1: 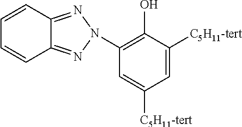
Ultraviolet absorber UV-2:

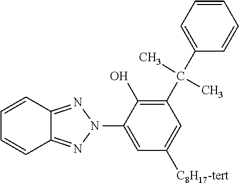

### (Preparation of Cellulose Acylate Film)

The cellulose acylate dope was cast on a drum of temperature of 20° C. The casted dope in which the solvent ratio was 20 weight % was separated from casting machine in, and then gripped with a clip, and drying. Then the casted dope was transported between rolls of heat treater, drying, and prepared the Support 4 (thickness: 25 μm).

### (1)-5 Preparation of Support

The following composition was put into a mixing tank, and was heated at 30° C. while being stirred to dissolve the components, thereby a cellulose acetate solution was prepared.

Composition of cellulose acetate solution (parts by mass)
Inner layer/outer layer

| | |
|---|---|
| Cellulose acetate with degree of acetylation of 60.9% | 100/100 |
| Triphenyl phosphate (plasticizer) | 7.8/7.8 |
| Biphenyl diphenyl phosphate (plasticizer) | 3.9/3.9 |
| Methylene chloride (first solvent) | 293/314 |
| Methanol (second solvent) | 71/76 |
| 1-Butanol (third solvent) | 1.5/1.6 |
| Silica particle (AEROSIL R972, available from Nippon Aerosil | 0/0.8 |
| Co., Ltd. ) | |
| The following retardation enhancer | 1.7/0 |

Retardation enhancer

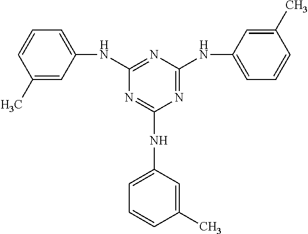 [SMILES: Cc1cccc(Nc2nc(Nc3cccc(C)c3)nc(Nc3cccc(C)c3)n2)c1]

The resultant inner-layer dope and outer-layer dope were casted onto a drum cooled at 0° C. with a three-layer co-casting die.

A film containing 70 mass % residual solvent was peeled off from the drum, and the film was dried at 80° C. while being conveyed at a draw rate of 110% in a conveying direction with both ends of the film being fixed with a pin tenter. When the amount of residual solvent decreased to 10%, the film was then dried at 110° C.

The film was then dried at 140° C. for 30 min to prepare a cellulose acetate film containing 0.3 mass % residual solvent, the film including a first outer layer 3 μm thick, an inner layer 74 μm thick, and a second outer layer 3 μm thick.

The optical characteristics of the resultant cellulose acetate film (support 11) were measured.

The cellulose acetate film had a width of 1340 mm, and a thickness of 80 μm. The retardation value (Re) at a wavelength of 500 nm of the film was 6 nm from measurement with an ellipsometer (M-150, available from JASCO Corporation)

The retardation value (Rth) at a wavelength of 500 nm of the film was 91 nm.

### (2) Transfer

A UV curable composition was applied onto a surface of each support to form an adhesion precursor layer.

The surface of the untransferred optically anisotropic layer of each transferring material produced as described above was brought into contact with the surface of the adhesion precursor layer of the support produced as described above to laminate the transferring material and the support. The resultant laminate was then pressed by a pressure roller and then irradiated with UV light to cure the UV curable composition, allowing the optically anisotropic layer to strongly adhere to the adhesion layer.

A highly tacky roll was then pressed to the back of the provisional substrate and rotated in order to separate the provisional substrate and the alignment film from the optically anisotropic layer.

In this way, the optical films were produced, in each of which the optically anisotropic layer was laminated on the support with the adhesion layer therebetween. The table below shows the total thickness of each optical film.

### (3) Evaluation of Optical Film

Evaluation of slight orientation deviation:

For each optical film, 3σ of slight orientation deviation was calculated in accordance with the evaluation procedure described above. The slight orientation deviation was then evaluated on the basis of the 3σ according to the following criterion.

A: less than 1.0

B: 1.0 to less than 2.0

C: 2.0 to less than 3.0

D: 3.0 or more

### 3. Production and Evaluation of Liquid Crystal Display

### (1) Production of Polarizing Plate

A polyvinyl alcohol (PVA) film 80 μm in thickness was dyed through immersion in an iodine solution containing 0.05 mass % iodine at 30° C. for 60 sec. The film was then immersed in a boric-acid solution containing 4 mass % boric acid for 60 sec. During such immersion, the film was longitudinally stretched to five times of its original length. The film was then dried at 50° C. for 4 min to yield a polarizing film 20 μm thickness.

A commercially available cellulose acetate film was immersed in a 1.5 mol/L of sodium hydroxide solution at 55° C., and was then washed with water to remove the sodium hydroxide. The cellulose acetate film was then immersed in a 0.005 mol/L of dilute sulfuric acid solution at 35° C. for 1 min. The film was then immersed in water to wash away the dilute sulfuric acid. The film was finally dried at 120° C.

Each optical film produced in the above-described manner and the saponified, commercially available cellulose acetate film were each bonded on a side of the polarizing film with a polyvinyl alcohol adhesive agent to produce a polarizing plate. In this bonding, the optically anisotropic layer of the optical film was on a side close to the liquid crystal cell. The commercially available cellulose acetate film was FUJITAC TF80UL (available from FUJIFILM Corporation). The polarizing film and the protective films on both sides of the polarizing film were each produced in a rolled form; hence, their longitudinal directions were parallel to one another, allowing the films to be continuously bonded together. As a result, the longitudinal direction of the rolled optical film, i.e., the cast direction of the cellulose acetate film, was parallel to the absorption axis of the polarizer.

### (2) Production of TN-Mode Liquid Crystal Display

A pair of polarizing plates originally provided in a liquid crystal display (AL2216W, available from Acer Japan Corp.) including a TN liquid crystal cell were removed to be replaced with the polarizing plates produced as described above. The polarizing plates, respectively, were bonded to a viewer side and a backlight side of the liquid crystal cell with a tacking agent such that the optical film was on a side close to the liquid crystal cell, i.e., the optical anisotropic layer was nearest to the liquid crystal cell. The polarizing plates were bonded such that the transmission axis of one polarizing plate on the viewer side was orthogonal to the transmission axis of the other polarizing plate on the backlight side.

### (3) Evaluation of TN-Mode Liquid Crystal Display

With the resultant liquid crystal displays, the front brightness in each of black and white states was measured with a luminance meter (BM-5, available from TOPCON CORPORATION), and the front contrast was calculated from the front brightness. The front contrast was evaluated based on the following criterion.

A: 1300 to less than 2000

B: 1000 to less than 1300

C: 700 to less than 1000

D: less than 700

The results are shown in the table below.

The grayscale inversion in both vertical and horizontal directions was evaluated with “EZ-Contrast 160D” (available from ELDIM) in the following manner. That is, the brightness was measured at a grayscale level (L1) at which the front brightness corresponded to 1/7 of the brightness in white display, and at a grayscale level (L2) at which the front brightness corresponded to 2/7 thereof. In addition, while a polar angle was gradually increased from 0 degrees, a specific polar angle (L1-to-L2 inversion start angle), at which a sign of the value of “brightness at the grayscale L1-brightness at the grayscale L2” was inverted, was determined as an index for evaluation according to the following criterion.

A: 50 degrees or more

B: 40 degrees to less than 50 degrees

C: more than 30 degrees to 40 degrees

D: 30 degrees or less

The results are shown in the following table.

TABLE 2

| | | Example 1 | Example 2 | Example 3 | Example 4 | Example 5 | Example 6 |
|---|---|---|---|---|---|---|---|
| Transfer material | | | | | | | |
| Provisional | Water contact angle on | 37° | 37° | 37° | 37° | 37° | 37° |
| substrate | alignment film side | | | | | | |
| Alignment | Material | Modified PVA | Modified PVA | Modified PVA | Modified PVA | Modified PVA | Modified PVA |
| layer | Proportion of polymerization | 0.5 | 0.5 | 0.5 | 0.5 | 0.5 | 0.5 |
| Optical | Alignment control agent at | (IIa) | (IIa)/(IIb) | (IIb) | (IIa) | (IId) | (III) |
| anisotropic layer | interface with alignment film | | | | | | |
| to be transferred | agent 1/agent 2 | | | | | | |
| | Amount of control agent, | 2 | 1.0/1.0 | 2 | 0.8 | 1.0 | 1.0 |
| | agent 1/agent 2, (parts by | | | | | | |
| | weight) | | | | | | |
| | Alignment control agent at | AD-4/AD-13 | AD-4/AD-13 | AD-4/AD-13 | AD-4/AD-13 | AD-4/AD-13 | AD-4/AD-13 |
| | interface with air | | | | | | |
| | agent 1/agent 2 | | | | | | |
| | Amount of control agent, | 0.6/0.2 | 0.6/0.2 | 0.6/0.2 | 0.6/0.2 | 0.6/0.2 | 0.6/0.2 |
| | agent 1/agent 2, (parts by | | | | | | |
| | weight) | | | | | | |
| | Tilt angle βb at interface with | 12 | 12 | 12 | 12 | 12 | 12 |
| | air | | | | | | |
| | Tilt angle βa at interface with | 72 | 80 | 88 | 70 | 88 | 72 |
| | alignment film | | | | | | |
| | Alignment mode | Reversed | Reversed | Reversed | Reversed | Reversed | Reversed |
| | | hybrid | hybrid | hybrid | hybrid | hybrid | hybrid |
| Separability | | A | A | B | C | D | D |
| Optical film | | | | | | | |
| Substrate | Material | Support 1 | Support 1 | Support 1 | Support 1 | Support 1 | Support 1 |
| | Rth (nm) | 35 | 35 | 35 | 35 | 35 | 35 |
| Optical | Tilt angle β2 at interface with | 75 | 80 | 88 | 70 | 88 | 72 |
| anisotropic layer | air (°) | | | | | | |
| to be transferred | Tilt angle β1 at interface with | 12 | 12 | 12 | 12 | 12 | 12 |
| | adhesion layer (°) | | | | | | |
| | Alignment mode | Normal hybrid | Normal hybrid | Normal hybrid | Normal hybrid | Normal hybrid | Normal hybrid |
| Total thickness (μm) | | 40 | 40 | 40 | 40 | 40 | 40 |
| 3σ of slight orientation deviation (°) | | A | A | A | A | A | A |
| Evaluation of liquid crystal display | | | | | | | |
| Front CR | | A | A | A | A | A | A |
| Grayscale inversion | | A | A | A | A | A | A |
| | | Example 7 | Example 8 | Example 9 | Example 10 | Example 11 | Example 12 |
| Transfer material | | | | | | | |
| Provisional | Water contact angle on | 37° | 37° | 37° | 59° | 37° | 37° |
| substrate | alignment film side | | | | | | |
| Alignment | Material | Modified PVA | Modified PVA | Unmodified | Modified PVA | Modified PVA | Modified PVA |
| layer | | | | PVA | | | |
| | Proportion of polymerization | 2.1 | 0.5 | 0 | 0.5 | 0.5 | 0.5 |
| Optical | Alignment control agent at | (IIa) | (IIa) | (IIa) | (IIa) | (IIa) | (IIa) |
| anisotropic layer | interface with alignment film | | | | | | |
| to be transferred | agent 1/agent 2 | | | | | | |
| | Amount of control agent, | 1.0 | 2.0 | 2.0 | 2.0 | 2.0 | 2.0 |
| | agent 1/agent 2, (parts by | | | | | | |
| | weight) | | | | | | |
| | Alignment control agent at | AD-4/AD-13 | AD-4/AD-13 | AD-4/AD-13 | AD-4/AD-13 | AD-4 | AD-13 |
| | interface with air | | | | | | |
| | agent 1/agent 2 | | | | | | |
| | Amount of control agent, | 0.6/0.2 | 0.6/0.2 | 0.6/0.2 | 0.6/0.2 | 0.8 | 0.8 |
| | agent 1/agent 2, (parts by | | | | | | |
| | weight) | | | | | | |
| | Tilt angle βb at interface with | 12 | 12 | 12 | 12 | 5 | 20 |
| | air | | | | | | |
| | Tilt angle βa at interface with | 72 | 72 | 72 | 72 | 72 | 72 |
| | alignment film | | | | | | |
| | Alignment mode | Reversed | Reversed | Reversed | Reversed | Reversed | Reversed |
| | | hybrid | hybrid | hybrid | hybrid | hybrid | hybrid |
| Separability | | D | A | A | C | A | A |
| Optical film | | | | | | | |
| Substrate | Material | Support 1 | -(*1) | Support 1 | Support 1 | Support 1 | Support 1 |
| | Rth (nm) | 35 | — | 35 | 35 | 35 | 35 |
| Optical | Tilt angle β2 at interface with | 72 | 72 | 72 | 72 | 72 | 72 |
| anisotropic layer | air (°) | | | | | | |
| to be transferred | Tilt angle β1 at interface with | 12 | 12 | 12 | 12 | 5 | 20 |
| | adhesion layer (°) | | | | | | |
| | Alignment mode | Normal hybrid | Normal hybrid | Normal hybrid | Normal hybrid | Normal hybrid | Normal hybrid |

| | | | | | | |
|---|---|---|---|---|---|---|
| Total thickness (μm) | 40 | 1 | 40 | 40 | 40 | 40 |
| 3σ of slight orientation deviation (°) | A | A | A | A | A | A |
| Evaluation of liquid crystal display | | | | | | |
| Front CR | A | A | A | A | A | A |
| Grayscale inversion | A | C | A | A | B | A |

| | | | | | Comparative | Comparative |
|---|---|---|---|---|---|---|
| | | Example 13 | Example 14 | Example 15 | example 1 | example 2 |
| Transfer material | | | | | | |
| Provisional | Water contact angle on | 37° | 37° | 37° | — | — |
| substrate | alignment film side | | | | | |
| Alignment | Material | Modified PVA | Modified PVA | Modified PVA | — | — |
| layer | Proportion of polymerization | 0.5 | 0.5 | 0.5 | — | — |
| Optical | Alignment control agent at | (IIa) | (IIa) | (IIa) | — | — |
| anisotropic layer | interface with alignment film | | | | | |
| to be transferred | agent 1/agent 2 | | | | | |
| | Amount of control agent, | 2.0 | 2.0 | 2.0 | — | — |
| | agent 1/agent 2, (parts by | | | | | |
| | weight) | | | | | |
| | Alignment control agent at | AD-4/AD-13 | AD-4/AD-13 | AD-4/AD-13 | — | — |
| | interface with air | | | | | |
| | agent 1/agent 2 | | | | | |
| | Amount of control agent, | 0.6/0.2 | 0.6/0.2 | 0.6/0.2 | — | — |
| | agent 1/agent 2, (parts by | | | | | |
| | weight) | | | | | |
| | Tilt angle βb at interface with | 12 | 12 | 12 | — | — |
| | air | | | | | |
| | Tilt angle βa at interface with | 72 | 72 | 72 | — | — |
| | alignment film | | | | | |
| | Alignment mode | Reversed | Reversed | Reversed | — | — |
| | | hybrid | hybrid | hybrid | | |
| Separability | | A | A | A | — | — |
| Optical film | | | | | | |
| Substrate | Material | Support 2 | Support 3 | Support 4 | Support 11 | Support 11 |
| | Rth (nm) | 60 | 80 | 19 | 91 | 91 |
| Optical | Tilt angle β2 at interface with | 75 | 75 | 75 | 12 | 75 |
| anisotropic layer | air (°) | | | | | |
| to be transferred | Tilt angle β1 at interface with | 12 | 12 | 12 | 75 | 12 |
| | adhesion layer (°) | | | | | |
| | Alignment mode | Normal hybrid | Normal hybrid | Normal hybrid | Reversed | Normal hybrid |
| | | | | | hybrid | |

| | | | | | |
|---|---|---|---|---|---|
| Total thickness (μm) | 40 | 40 | 25 | 80 | 80 |
| 3σ of slight orientation deviation (°) | A | A | A | A | D |
| Evaluation of liquid crystal display | | | | | |
| Front CR | A | A | A | A | D |
| Grayscale inversion | B | C | A | D | C |

The present disclosure relates to the subject matter contained in Japanese Patent Application No. 218157/2011 filed on Sep. 30, 2011, and Japanese Patent Application No. 206570/2012 filed on Sep. 20, 2012 which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. An optical film comprising, an optically anisotropic layer comprising discotic liquid crystal fixed into a hybrid alignment, an adhesion layer having no alignment controllability and a substrate in that order,
wherein the hybrid alignment is conditioned such that an angle defined by a director of the discotic liquid crystal in a region close to an interface with air and the normal to the film is larger than an angle defined by a director of the discotic liquid crystal in the vicinity of an interface with the adhesion layer and the normal to the film, and the total thickness of the film is 0.1 μm to 70 μm.

2. The optical film according to claim 1, wherein the hybrid alignment is conditioned such that the angle defined by the director of the discotic liquid crystal in the vicinity of the interface with the adhesion layer and the normal to the film is 0° to 40°, and the angle defined by the director of the discotic liquid crystal in the region close to the interface with air and the normal to the film is 50° to 90°.

3. The optical film according to claim 1, wherein the optically anisotropic layer further comprises at least one of compounds represented by formula (1): 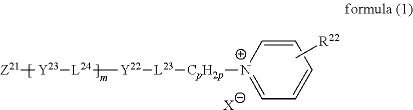
wherein L²³ and L²⁴ each represent a divalent linking group; R²² represents a hydrogen atom, an unsubstituted amino group, or a substituted amino group containing 1 to 20 carbon atoms; X represents an anion, Y²² and Y²³ each represent a divalent linking group having an optionally substituted five- or six-membered ring as a partial structure; Z²¹ represents a monovalent group selected from the group consisting of alkyl groups containing 13 to 20 carbon atoms, alkynyl groups containing 13 to 20 carbon atoms, and alkoxy groups containing 13 to 20 carbon atoms; p is an integer of 1 to 10; and m is 1 or 2.

4. The optical film according to claim 3, wherein the proportion of at least one of the compounds represented by formula (1) contained in the optically anisotropic layer is 1 to 5 parts by mass to 100 parts by mass of the discotic liquid crystal.

5. The optical film according to claim 1, wherein the substrate is a polymer film.

6. The optical film according to claim 5, wherein the polymer film has a retardation along the thickness direction Rth of 0 nm to 80 nm.

7. The optical film according to claim 1, wherein the substrate is a polarizer.

8. The optical film according to claim 1, wherein the optically anisotropic layer further comprises at least one of compounds represented by formula (1); and the proportion of at least one of the compounds represented by formula (1) contained in the optically anisotropic layer is 1 to 5 parts by mass to 100 parts by mass of the discotic liquid crystal: 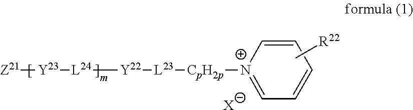
wherein L²³ and L²⁴ each represent a divalent linking group; R²² represents a hydrogen atom, an unsubstituted amino group, or a substituted amino group containing 1 to 20 carbon atoms; X represents an anion, Y²² and Y²³ each represent a divalent linking group having an optionally substituted five- or six-membered ring as a partial structure; Z²¹ represents a monovalent group selected from the group consisting of alkyl groups containing 13 to 20 carbon atoms, alkynyl groups containing 13 to 20 carbon atoms, and alkoxy groups containing 13 to 20 carbon atoms; p is an integer of 1 to 10; and m is 1 or 2.

9. The optical film according to claim 1, wherein the optically anisotropic layer further comprises at least one of compounds represented by formula (1), and the substrate is a polymer film: 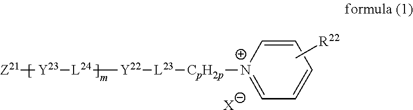
wherein L²³ and L²⁴ each represent a divalent linking group; R²² represents a hydrogen atom, an unsubstituted amino group, or a substituted amino group containing 1 to 20 carbon atoms; X represents an anion, Y²² and Y²³ each represent a divalent linking group having an optionally substituted five- or six-membered ring as a partial structure; Z²¹ represents a monovalent group selected from the group consisting of alkyl groups containing 13 to 20 carbon atoms, alkynyl groups containing 13 to 20 carbon atoms, and alkoxy groups containing 13 to 20 carbon atoms; p is an integer of 1 to 10; and m is 1 or 2.

10. The optical film according to claim 3, wherein the proportion of at least one of the compounds represented by formula (1) contained in the optically anisotropic layer is 1 to 5 parts by mass to 100 parts by mass of the discotic liquid crystal; and the substrate is a polymer film.

11. The optical film according to claim 1, wherein the substrate is a polymer film; and a retardation along the thickness direction Rth of the polymer film is 0 nm to 80 nm.

12. The optical film according to claim 1, wherein the optically anisotropic layer further comprises at least one of compounds represented by formula (1), the substrate is a polymer film; and a retardation along the thickness direction Rth of the polymer film is 0 nm to 80 nm: 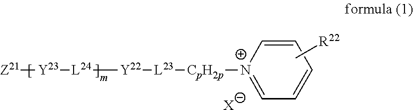
wherein L²³ and L²⁴ each represent a divalent linking group; R²² represents a hydrogen atom, an unsubstituted amino group, or a substituted amino group containing 1 to 20 carbon atoms; X represents an anion, Y²² and Y²³ each represent a divalent linking group having an optionally substituted five- or six-membered ring as a partial structure; Z²¹ represents a monovalent group selected from the group consisting of alkyl groups containing 13 to 20 carbon atoms, alkynyl groups containing 13 to 20 carbon atoms, and alkoxy groups containing 13 to 20 carbon atoms; p is an integer of 1 to 10; and m is 1 or 2.

13. A liquid crystal display comprising: the optical film according to claim 1.

14. A transfer material comprising, in that order:
an optically anisotropic layer to be transferred comprising discotic liquid crystal molecules comprising discotic liquid crystal fixed into a hybrid alignment;
a rubbed alignment layer; and
a provisional substrate, wherein
the hybrid alignment is conditioned such that an angle defined by a director of the discotic liquid crystal in a region close to an interface with air and the normal to a film is smaller than an angle defined by a director of the discotic liquid crystal in the vicinity of an interface with the alignment layer and the normal to the film, and
the optically anisotropic layer to be transferred is separable from the alignment layer at an interface between the optically anisotropic layer and the alignment layer.

15. The transfer material according to claim 14, wherein the hybrid alignment is conditioned such that the angle defined by the director of the discotic liquid crystal in the vicinity of the interface with the alignment layer and the normal to the film is 50° to 90°, and the angle defined by the director of the discotic liquid crystal in the region close to the interface with air and the normal to the film is 0° to 40°.

16. The transfer material according to claim 14, wherein the optically anisotropic layer to be transferred further comprises at least one of the compounds represented by formula (1): 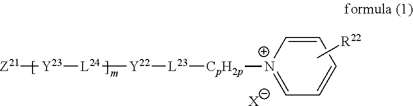
wherein L²³ and L²⁴ each represent a divalent linking group; R²² represents a hydrogen atom, an unsubstituted amino group, or a substituted amino group containing 1 to 20 carbon atoms; X represents an anion, Y²² and Y²³ each represent a divalent linking group having an optionally substituted five- or six-membered ring as a partial structure; Z²¹ represents a monovalent group selected from the group consisting of alkyl groups containing 13 to 20 carbon atoms, alkynyl groups containing 13 to 20 carbon atoms, and alkoxy groups containing 13 to 20 carbon atoms; p is an integer of 1 to 10; and m is 1 or 2.

17. The transfer material according to claim 16, wherein the proportion of at least one of the compounds represented by the formula (1) contained in the optically anisotropic layer to be transferred is preferably 1 to 5 parts by mass to 100 parts by mass of the discotic liquid crystal.

18. The transfer material according to claim 14, wherein the alignment layer comprises unmodified or modified polyvinyl alcohol as a main component.

19. The transfer material according to claim 18, wherein a water contact angle on a surface close to the alignment layer of the provisional substrate is 10° to 50°.

20. A method of manufacturing the optical film according to claim 1, the method comprising, in the sequence set forth of:
preparing (1) a transferring material comprising, in that order: an optically anisotropic layer to be transferred comprising discotic liquid crystal molecules comprising discotic liquid crystal fixed into a hybrid alignment; a rubbed alignment layer; and a provisional substrate, wherein the hybrid alignment is conditioned such that an angle defined by a director of the discotic liquid crystal in a region close to an interface with air and the normal to a film is smaller than an angle defined by a director of the discotic liquid crystal in the vicinity of an interface with the alignment layer and the normal to the film, and the optically anisotropic layer to be transferred is separable from the alignment layer at an interface between the optically anisotropic layer and the alignment layer, and (2) a laminate comprising a substrate and an adhesion layer or adhesion precursor layer having no alignment controllability on a surface of the substrate;
bringing a surface on a side close to the optically anisotropic layer to be transferred of the transferring material into contact with a surface of the adhesion layer or a surface of the adhesion precursor layer of the laminate; and
separating the provisional substrate and the alignment layer from the transferring material, thereby transferring the optically anisotropic layer onto the surface of the adhesion layer.
